(19) United States
(12) Patent Application Publication
(10) Pub. No.: US 2025/0266947 A1
(43) Pub. Date: Aug. 21, 2025

(54) TRANSMISSION AND RECEPTION IN WIRELESS COMMUNICATION

(71) Applicant: Samsung Electronics Co., Ltd., Suwon-si (KR)

(72) Inventors: Marian Rudolf, Longueuil (CA); Eko Onggosanusi, Coppell, TX (US)

(21) Appl. No.: 19/186,567

(22) Filed: Apr. 22, 2025

Related U.S. Application Data
(60) Provisional application No. 63/645,676, filed on May 10, 2024.
(60) Provisional application No. 63/704,268, filed on Oct. 7, 2024.

(51) Int. Cl. H04L 5/00; H04L 5/14

(52) U.S. Cl. CPC H04L 5/0044; H04L 5/0012; H04L 5/14

(57) ABSTRACT

Apparatuses and methods for transmission and reception in wireless communications. A method for a user equipment (UE) includes receiving first information for first symbols in a slot, receiving second information for an uplink (UL) grant downlink control information (DCI) associated with transmission of a physical uplink shared channel (PUSCH) in a second symbols in the slot, and receiving third information for a condition. The slot is associated with resource element (RE) muting on a symbol from the first symbols. The method further includes determining, based on the condition, that a symbol of the second symbols is included in the first symbols in the slot, determining a number of symbols associated with RE muting for transmission of the PUSCH on the second symbols, and transmitting the number of symbols from the second symbols based on the first information when the condition is valid and the second information when not valid.

### CROSS-REFERENCE TO RELATED AND CLAIM OF PRIORITY

The present application claims priority under 35 U.S.C. § 119 (e) to U.S. Provisional Patent Application No. 63/645,676 filed on May 10, 2024 and U.S. Provisional Patent Application No. 63/704,268 filed on Oct. 7, 2024, which are hereby incorporated by reference in their entirety.

### TECHNICAL FIELD

The present disclosure relates generally to wireless communication systems and, more specifically, the present disclosure is related to apparatuses and methods for transmission and reception in wireless communications.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to transmission and reception in wireless communications.

In one embodiment, a method for a user equipment (UE) to transmit a physical uplink shared channel (PUSCH) is provided. The method includes receiving first information for a first set of symbols in a slot, receiving second information for an uplink (UL) grant downlink control information (DCI) associated with transmission of the PUSCH in a second set of symbols in the slot, and receiving third information for a condition. The slot is associated with resource element (RE) muting on a symbol from the first set of symbols. The method further includes determining, based on the condition, that a symbol of the second set of symbols is included in the first set of symbols in the slot, determining a number of symbols associated with RE muting for transmission of the PUSCH on the second set of symbols, and transmitting the number of symbols from the second set of symbols based on the first information when the condition is valid and the second information when the condition is not valid.

In another embodiment, a UE is provided. The UE includes a transceiver configured to, receive first information for a first set of symbols in a slot, receive second information for an UL grant DCI associated with transmission of a PUSCH in a second set of symbols in the slot, and receive third information for a condition. The slot is associated with RE muting on a symbol from the first set of symbols. The UE further includes a processor operably coupled to the transceiver. The processor is configured to determine, based on the condition, that a symbol of the second set of symbols is included in the first set of symbols in the slot and determine a number of symbols associated with RE muting for transmission of the PUSCH on the second set of symbols. The transceiver is further configured to transmit the number of symbols from the second set of symbols based on the first information when the condition is valid and the second information when the condition is not valid.

In yet another embodiment, a base station (BS) is provided. The BS includes a transceiver configured to transmit first information for a first set of symbols in a slot, transmit second information for an UL grant DCI associated with reception of the PUSCH in a second set of symbols in the slot, and transmit third information for a condition. The slot is associated with RE muting on a symbol from the first set of symbols. The BS further includes processor operably coupled to the transceiver. The processor is configured to determine, based on the condition, that a symbol of the second set of symbols is included in the first set of symbols in the slot and determine a number of symbols associated with RE muting for reception of the PUSCH on the second set of symbols. The transceiver is further configured to receive the number of symbols from the second set of symbols based on the first information when the condition is valid, and the second information when the condition is not valid.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a timeline for time division duplexing according to embodiments of the present disclosure;

FIG. 11 illustrates timelines for full duplexing according to embodiments of the present disclosure;

FIG. 12 illustrates a diagram of an example transparent resource muting pattern according to the embodiments of the present disclosure;

FIG. 13 illustrates a diagram of an example transparent resource muting pattern according to the embodiments of the present disclosure;

FIG. 14 illustrates a diagram of an example non-transparent resource muting pattern according to the embodiments of the present disclosure;

FIG. 15 illustrates a diagram of an example non-transparent resource muting pattern according to the embodiments of the present disclosure;

FIG. 16 illustrates a diagram of an example non-transparent resource muting pattern according to the embodiments of the present disclosure;

FIG. 17 illustrates a diagram of an example transparent resource muting pattern according to the embodiments of the present disclosure;

FIG. 18 illustrates a diagram of an example transparent resource muting pattern according to the embodiments of the present disclosure;

FIG. 19 illustrates a diagram of example demodulation reference signal (DM-RS) configurations according to the embodiments of the present disclosure;

FIG. 20 illustrates a flowchart of an example UE procedure for applying an uplink (UL) muting pattern to a PUSCH transmission according to the embodiments of the present disclosure;

FIG. 21 illustrates a flowchart of an example UE procedure for applying an UL muting pattern to a PUSCH transmission according to the embodiments of the present disclosure;

FIG. 22 illustrates a diagram of example DM-RS configurations according to the embodiments of the present disclosure; and

FIG. 23 illustrates a flowchart of an example UE procedure for applying an UL muting pattern to a PUSCH transmission according to the embodiments of the present disclosure.

### DETAILED DESCRIPTION

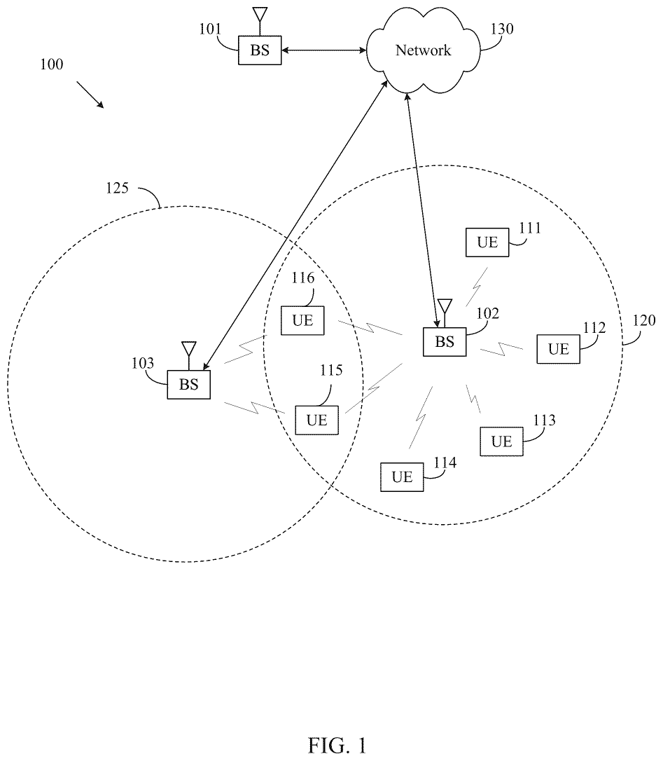

FIGS. 1-23 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: (REF 1) 3GPP TS 38.211 v18.2.0 and v18.3.0, “NR; Physical channels and modulation;” (REF 2) 3GPP TS 38.212 v18.2.0 and v28.3.0, “NR; Multiplexing and Channel coding;” (REF 3) 3GPP TS 38.213 v18.2.0 and v18.3.0, “NR; Physical Layer Procedures for Control;” (REF 4) 3GPP TS 38.214 v18.2.0 and v18.3.0, “NR; Physical Layer Procedures for Data”; (REF 5) 3GPP TS 38.321 v18.1.0 and v18.2.0, “NR; Medium Access Control (MAC) protocol specification;” (REF 6) 3GPP TS 38.331 v18.1.0 and v18.2.0, “NR; Radio Resource Control (RRC) Protocol Specification;” (REF 7) 3GPP TS 38.133 v18.3.0 and v18.6.0, “NR; Requirements for support of radio resource management;” and (REF 8) 3GPP TS 38.101-1/-2/-3 v18.6.0/18.6.0/18.6.0, “NR; UE radio transmission and reception; Part 1: Range 1 Standalone/Part 2: Range 2 Standalone/Part 3: Range 1 and Range 2 Interworking operation with other radios.”

FIGS. 1-23 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for transmission and reception in wireless communications. In certain embodiments, one or more of the BSs 101-103 include circuitry, programing, or a combination thereof to support transmission and reception in wireless communications.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

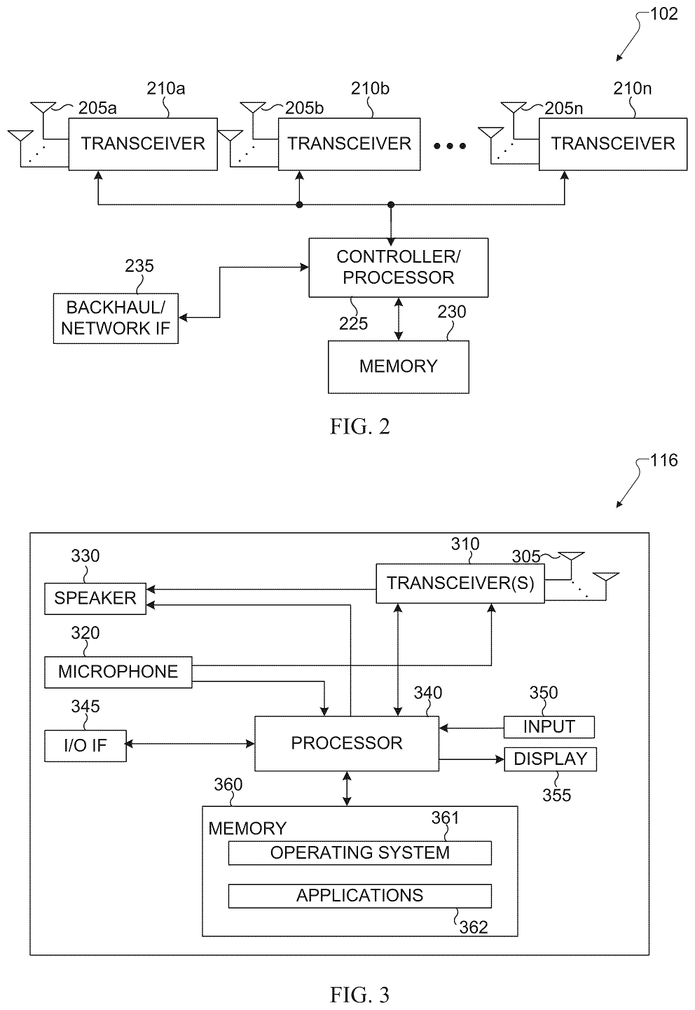

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for transmission and reception in wireless communications. Any of a wide variety of other functions could be supported in the gNB 102 by the controller/processor 225.

The controller/processor 225 is also capable of executing programs and other processes resident in the memory 230, such as processes to support transmission and reception in wireless communications. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for transmission and reception in wireless communications as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

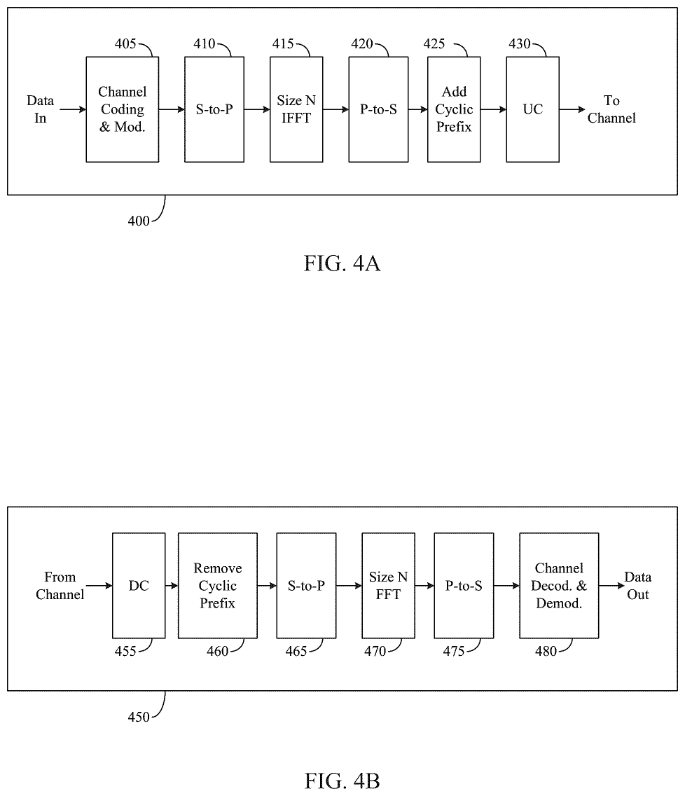

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for transmission in wireless communications as described in embodiments of the present disclosure. In some embodiments, the receive path 450 is configured for reception in wireless communications as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

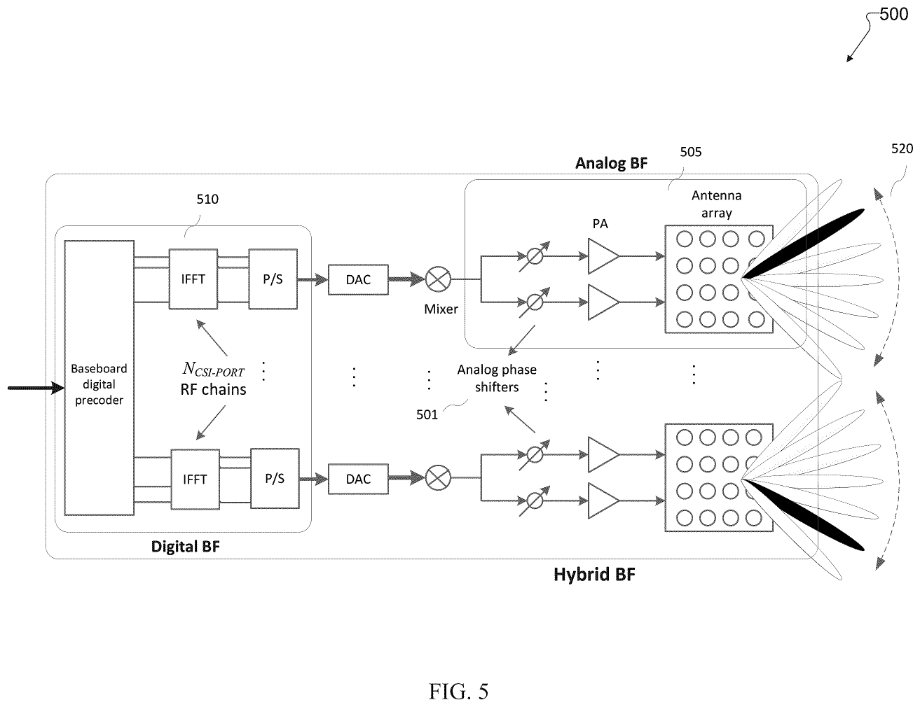

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state indication CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to UE procedures for transmitting the physical uplink shared channel (PUSCH) in a time-division duplex (TDD) or full-duplex (FD) wireless system in order to improve system operation according to channel conditions or to reduce UE modem complexity.

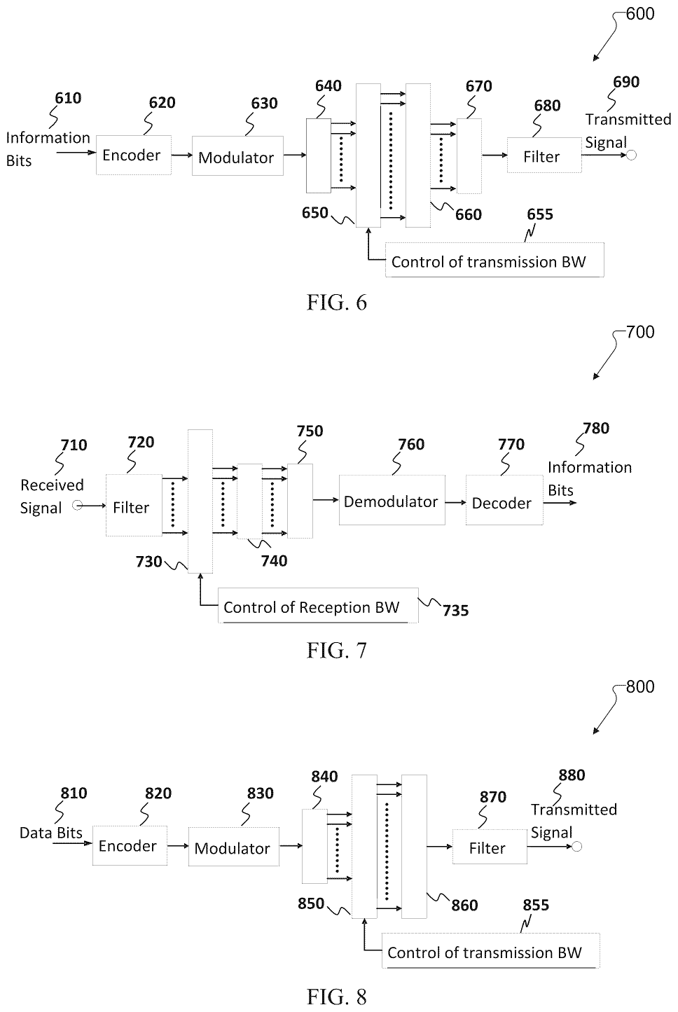

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission bandwidth (BW) selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DM-RS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

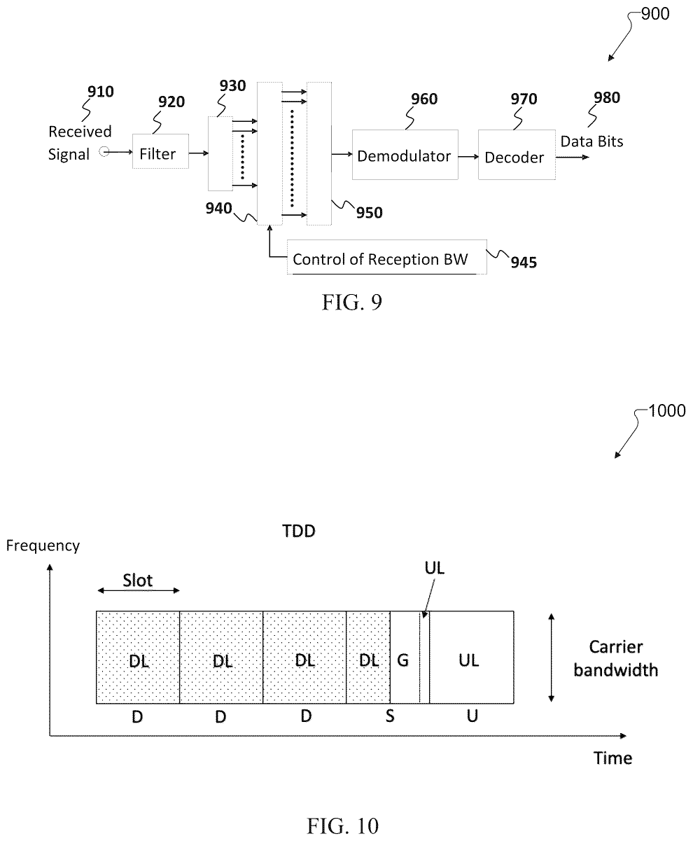

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DM-RS (not shown), a decoder 970, such as a turbo decoder, decodes the demodulated data to provide an estimate of the information data bits 980.

5G radio supports flexible spectrum utilization from 400 MHz to 90 GHz for licensed, unlicensed, and shared spectrum bands, narrow-band and wideband allocations with bandwidth parts, carrier aggregation, dual-connectivity, and dynamic spectrum sharing, achieves higher spectrum occupancy than LTE, and utilizes flexible control channel assignments in time and frequency domains. In-built support since 3GPP Release 15 for massive MIMO and beamforming greatly enhances achievable coverage and spectral efficiency when using 5G radio. Flexible orthogonal frequency division multiplexing (OFDM) numerology, short transmission time and scheduling delays, self-contained slots, asynchronous hybrid automatic repeat request acknowledgement (HARQ), minimal overhead from DL common signals and channels, adaptive reference signals and low-density parity check (LDPC) and Polar channel coding enable more flexibility and faster processing with 5G radio when compared to LTE.

In addition, 5G radio provides optimized support for additional services and features in 3GPP Release 16 such as vehicular (V2X) and device-to-device (D2D) communications, wireless backhauling (IAB), coordinated multi-point (COMP) or Multi-TRP transmission and reception (multi-TRP), cross-link interference (CLI) and remote interference (RIM) detection and avoidance, and NR operation in unlicensed bands (NR-U).

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB (e.g., the BS 102) transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI)/configured scheduling (CS)-RNTI/modulation and coding scheme (MCS)-C-RNTI as described in (REF 2), are referred for brevity as a unicast DCI format. A DCI format scheduling PDSCH reception for multicast communication, such as a DCI format with CRC scrambled by group RNTI (G-RNTI)/G-CS-RNTI as described in (REF 2), are referred to as multicast DCI format. DCI formats providing various control information to at least a subset of UEs in a serving cell, such as DCI format 2_0 in (REF 2), are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal SS/PBCH block transmissions.

In absence of CSI-RS configuration, and unless otherwise configured, the UE may expect PDSCH DM-RS and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are QCL with QCL type A, type D (when applicable) and average gain. The UE may further expect that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the physical cell ID (PCI) of the serving cell. Additionally, the DL or Joint TCI states can be associated with a cell having a PCI different from the PCI of the serving cell, e.g. the source RS of the TCI state is associated with a cell having a PCI different from the PCI of the serving cell. The UL-TCIState can include UL TCI states that belong to a serving cell, e.g. the source RS of the TCI state is associated with the serving cell (the PCI of the serving cell); additionally, the UL TCI states can be associated with a cell having a PCI different from the PCI of the serving cell, e.g. the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous physical resource blocks (PRBs) which represents the smallest frequency unit for CSI or calibration coefficient reporting. The number of PRBs in a subband can be fixed for a given value of DL system bandwidth, configured either via higher layer/RRC signaling, or via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mn subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

FIG. 10 illustrates a timeline 1000 for time division duplexing according to embodiments of the present disclosure. For example, timeline 1000 can be followed by the UE 116 and the gNB 102 and/or network 130 in the wireless network 100 of FIG. 1. This example is for illustration only and other embodiments can be used without departing from the scope of the present disclosure.

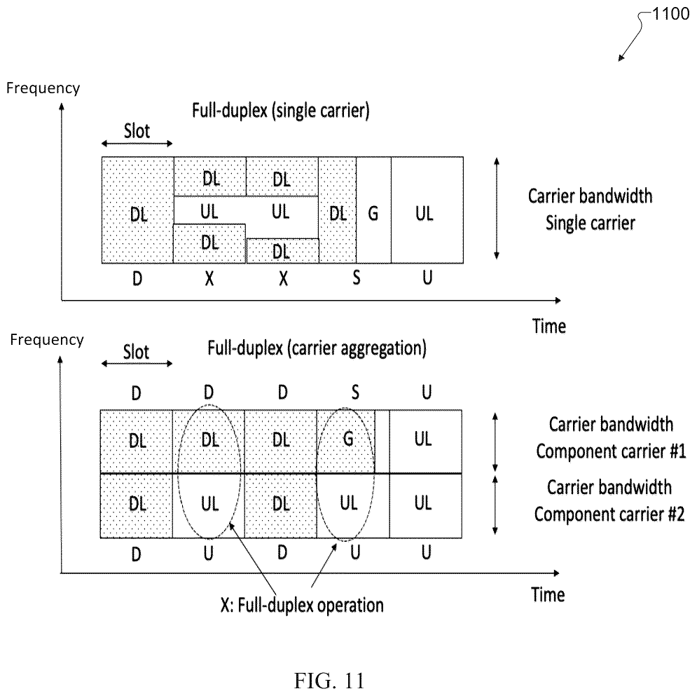

FIG. 11 illustrates timelines 1100 for full duplexing according to embodiments of the present disclosure. For example, timelines 1100 can be followed by the UE 116 and the gNB 102 and/or network 130 in the wireless network 100 of FIG. 1. This example is for illustration only and other embodiments can be used without departing from the scope of the present disclosure.

A DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL taking into account an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in (REF 3), that can indicate a link direction of some flexible symbols in one or more slots. In actual deployments, it is difficult for a gNB scheduler to adapt a transmission direction of symbols without coordination with other gNB schedulers in the network (e.g., the network 130). This is because of CLI where, for example, DL receptions in a cell by a UE can experience large interference from UL transmissions in the same or neighboring cells from other UEs.

Full-duplex (FD) communications may offer increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping subbands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL subbands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, SBFD DL subbands and one SBFD UL subband on the full-duplex slot or symbol. A frequency-domain configuration of the SBFD DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbols and non-full-duplex slots/symbols and normal DL or UL slot/symbols may be referred to as non-SBFD slots/symbols.

Instead of using a single NR carrier for full-duplex operation, different component carriers (CCs) may be used for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can either transmit or receive at a same time but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by the UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and the UE1 can transmit and receive simultaneously in a slot or symbol when configured, scheduled, assigned or indicated by the gNB (e.g., the BS 102), but UE2 supports half-duplex operation and can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, the term Full-Duplex (FD) is used as a short form for a full-duplex operation in a wireless system. The terms ‘cross-division-duplex’ (XDD), ‘full duplex’ (FD) and ‘subband-full-duplex’ (SBFD) may be used interchangeably in the disclosure.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

For a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

For a carrier aggregation TDD configuration with FD enabled, a UE (e.g., the UE 116) receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrates diagrams, various changes may be made to the diagrams 1000-1100 of FIGS. 10-11. For example, while certain diagrams (such as diagrams 1000, 1100) describe a certain slot structure, various components combined, further subdivided, or omitted and additional components can be added according to particular needs.

In the following and throughout the disclosure, various embodiments of the disclosure may be also implemented in any type of UE including, for example, UEs with the same, similar, or more capabilities compared to common 5G NR UEs. Although various embodiments of the disclosure discuss 3GPP 5G NR communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (e.g., the network 130) (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=19 for Rel-19, or xx=20 for Rel-20, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of a master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in (REF 3).

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a UE may be provided with an SBFD configuration based on a parameter sbfd-config to determine receptions and/or transmissions on a serving cell supporting full-duplex operation. For example, the UE may be provided with a set of RBs or a set of symbols for an SBFD UL or DL subband on a symbol or in a slot based on sbfd-config. For example, the UE may be provided with a set of symbols or slots for an SBFD subband based on sbfd-config. An SBFD configuration may be provided by higher layers, e.g., RRC, or may be indicated based on DCI and/or MAC-CE signaling. A combination of SBFD configuration based on higher layer parameters such as sbfd-config and indication through DCI and/or MAC-CE signaling may also be used. The UE may determine an SBFD configuration for a symbol or a slot or a set of symbols or a set of slots using higher layer parameters provided for an SBFD configuration and based on reception or transmission conditions such as a slot type ‘D’, ‘U’, or ‘F’. In one example, the SBFD configuration and/or parameters associated with the SBFD configuration are same for TRPs. In one example, the SBFD configuration and/or parameters associated with the SBFD configuration can be TRP specific following the configuration examples mentioned herein.

For example, an SBFD configuration may provide a set of time-domain resources, e.g., symbols/slots, where receptions or transmissions by the UE are allowed or disallowed. An SBFD configuration may provide a range or a set of frequency-domain resources, e.g., serving cell, BWP, start and/or end or a set of RBs, where receptions or transmissions by the UE are allowed or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as ‘non-SBFD symbol’ or ‘SBFD symbol’, or ‘simultaneous Tx-Rx’, ‘Rx only’, ‘Tx only’ or ‘D’, ‘U’, ‘F’, ‘N/A’. An SBFD configuration may be associated with one or multiple scheduling behaviors, e.g., for “dynamic grant”, for “configured grant”, for “any”. An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB, or to determine the power and/or spatial settings for transmissions by the UE.

For example, a UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot (frequency domain resources). For example, the UE may be provided with a set of symbols or slots for an SBFD subband (time domain resources). In one example, the SBFD configuration applies to TRPs in the cell. In one example, the SBFD configurations are separately provided for each TRP in the cell. In one example, a common SBFD configuration is provided for a cell and an additional delta configuration is separately provided for each TRP in the cell, wherein the delta configuration can include additional frequency/time domain resources to be added to the common configuration and/or excluded frequency/time domain resources to be excluded from the common configuration. In one example, the SBFD configurations are separately provided for each TRP in the cell. In one example, a common SBFD configuration is provided for a first TRP of the cell and an additional delta configuration is provided for each other TRP in the cell, wherein the delta configuration can include additional frequency/time domain resources to be added to the common configuration and/or excluded frequency/time domain resources to be excluded from the common configuration.

For example, an SBFD configuration and/or parameters associated with SBFD configuration based on sbfd-config may be provided by higher layer, e.g., RRC, or may be indicated based on DCI and/or MAC-CE signaling. A combination of SBFD configuration and/or parameterization based on higher layer parameters and indication through DCI and/or MAC-CE signaling may be used. The UE may determine an SBFD configuration for a symbol or a slot or a set of symbols or a set of slots using higher layer parameters provided for an SBFD configuration and based on reception or transmission conditions such as for a slot or symbol type ‘D’, ‘U’, or ‘F or a slot or a symbol type ‘SBFD’ or ‘non-SBFD’ or for an SBFD subband type such as ‘SBFD DL subband’, ‘SBFD UL subband’, or ‘SBFD Flexible subband’.

For example, an SBFD configuration may provide a set of time-domain resources, e.g., symbols/slots, where receptions or transmissions by the UE are allowed or disallowed. In one example, the time-domain resources are same (e.g., common) for TRPs as mentioned herein. In another example, the time-domain resources can be different for each TRP, as mentioned herein. An SBFD configuration may provide a range or a set of frequency-domain resources, e.g., serving cell, BWP, start and/or end or a set of RBs, where receptions or transmissions by the UE are allowed or disallowed. In one example, the frequency-domain resources are same (e.g., common) to TRPs as mentioned herein. In another example, the frequency-domain resources can be different for each TRP, as mentioned herein. An SBFD configuration may provide one or multiple guard intervals or guard RBs for time and/or frequency domain radio resources during receptions or transmissions by the UE, e.g., guard SCs or RBs, guard symbols, wherein the provided SBFD configuration may be same or different for each TRP as mentioned herein. An SBFD configuration may be provided based on one or multiple resource types such as non-SBFD symbol′ or ‘SBFD symbol’, or ‘simultaneous Tx-Rx’, ‘Rx only’, ‘Tx only’ or ‘D’, ‘U’, ‘F’, ‘N/A’. In one example, SBFD configuration is performed at a slot level. In one example, SBFD configuration is performed at a symbol level. In one example, SBFD configuration is performed at a slot level and symbol level. In one example, An SBFD configuration may be associated with one or multiple scheduling behaviors, e.g., for “dynamic grant”, for “configured grant”, for “any”. An SBFD configuration and/or parameters associated with an SBFD configuration may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE.

For example, an SBFD configuration and/or parameters associated with the SBFD configuration may be provided to the UE by means of common RRC signaling using SIB, or be provided by UE-dedicated RRC signaling such as ServingCellConfig. For example, an SBFD configuration and/or parameters associated with the SBFD configuration may be provided to the UE using an RRC-configured time domain resource assignment (TDRA) table, or a PDCCH, PDSCH, PUCCH or PUSCH configuration, and/or DCI-based signaling that can indicate to the UE a configuration or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding resource blocks (RBs) in an NR carrier BW that are not within a configured or an active UE BWP. An SBFD subband configuration may be provided based on a reference RB and/or based on a reference subcarrier spacing (SCS). The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration for sbfd-config may be provided to the UE using tdd-UL-DL-ConfigurationCommon as example for RRC common configuration and/or tdd-UL-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE or by RRC signaling when the UE is configured with an SCell or additional SCGs by an IE ServingCellConfigCommon in RRC_CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types ‘D’, ‘U’ or ‘F’ using at least one time-domain pattern with configurable periodicity.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

In certain embodiments, a cell may include more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

The principle of inter-gNB CLI estimation and equalization by an gNB advanced receiver has been provided for 5G NR in the context of dynamic TDD operation and for subband-full duplex based operation.

For example, an expectation for gNB UL receiver design is that the gNB-to-gNB interference covariance matrix can't be estimated and therefore it is not used as input for the gNB receiver. This type of receiver can be denoted as LMMSE-IRC and can more generally be regarded as baseline. Several variations exist.

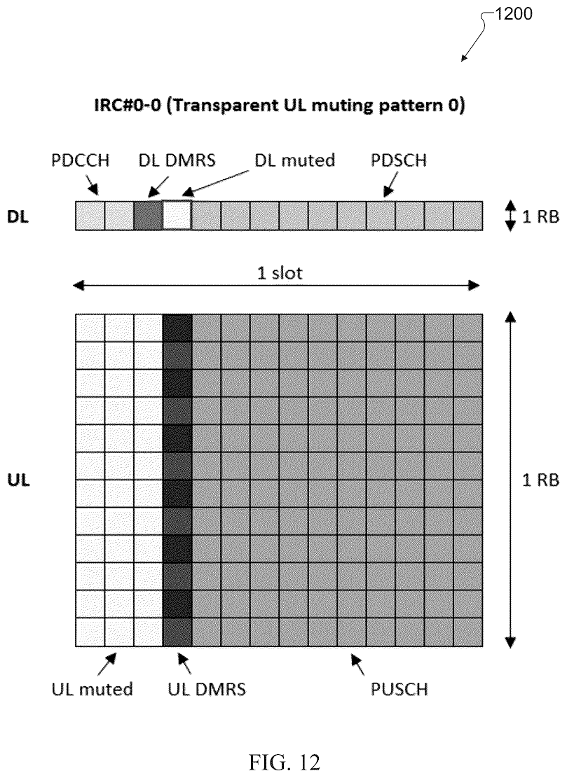

FIG. 12 illustrates a diagram of an example transparent resource muting pattern 1200 according to the embodiments of the present disclosure. For example, transparent resource muting pattern 1200 can be implemented by the UE 111 and the gNB 102 and/or network 130 in the wireless network 100 of FIG. 1. This example is for illustration only and other embodiments can be used without departing from the scope of the present disclosure.

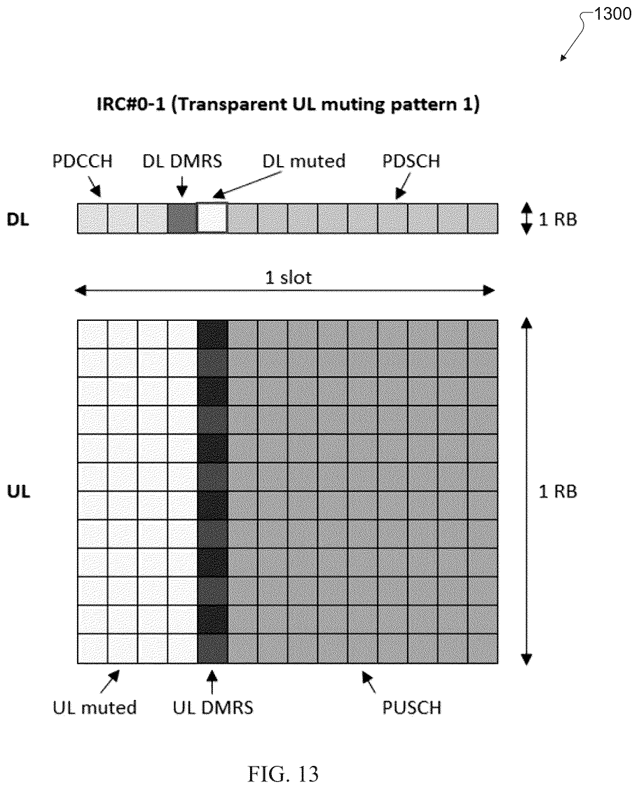

FIG. 13 illustrates a diagram of an example transparent resource muting pattern 1300 according to the embodiments of the present disclosure. For example, transparent resource muting pattern 1300 can be implemented by the UE 112 and the gNB 102 and/or network 130 in the wireless network 100 of FIG. 1. This example is for illustration only and other embodiments can be used without departing from the scope of the present disclosure.

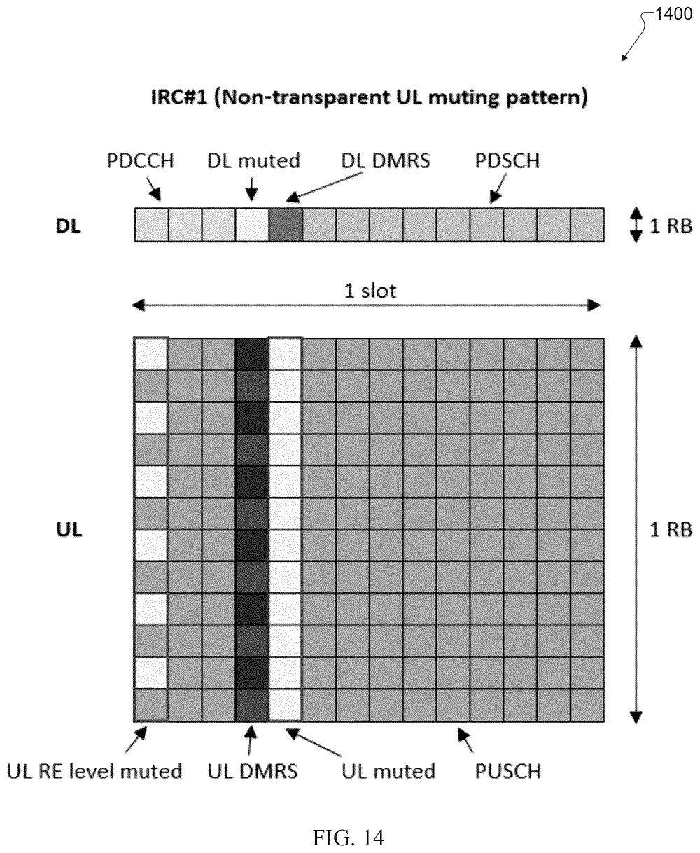

FIG. 14 illustrates a diagram of an example non-transparent resource muting pattern 1400 according to the embodiments of the present disclosure. For example, non-transparent resource muting pattern 1400 can be implemented by the UE 113 and the gNB 103 and/or network 130 in the wireless network 100 of FIG. 1. This example is for illustration only and other embodiments can be used without departing from the scope of the present disclosure.

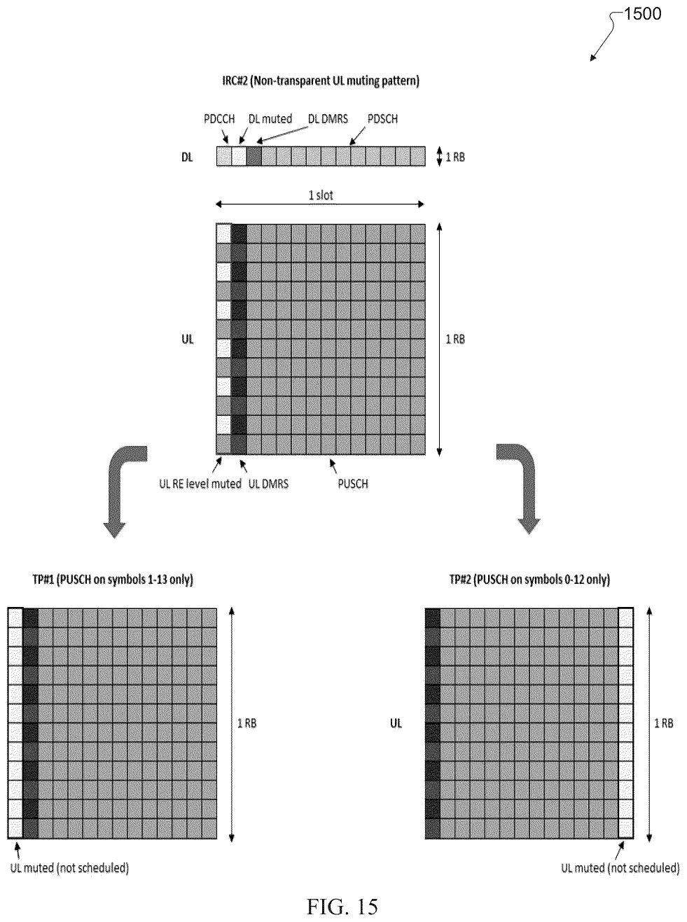

FIG. 15 illustrates a diagram of an example non-transparent resource muting pattern 1500 according to the embodiments of the present disclosure. For example, non-transparent resource muting pattern 1500 can be implemented by the UE 114 and the gNB 102 and/or network 130 in the wireless network 100 of FIG. 1. This example is for illustration only and other embodiments can be used without departing from the scope of the present disclosure.

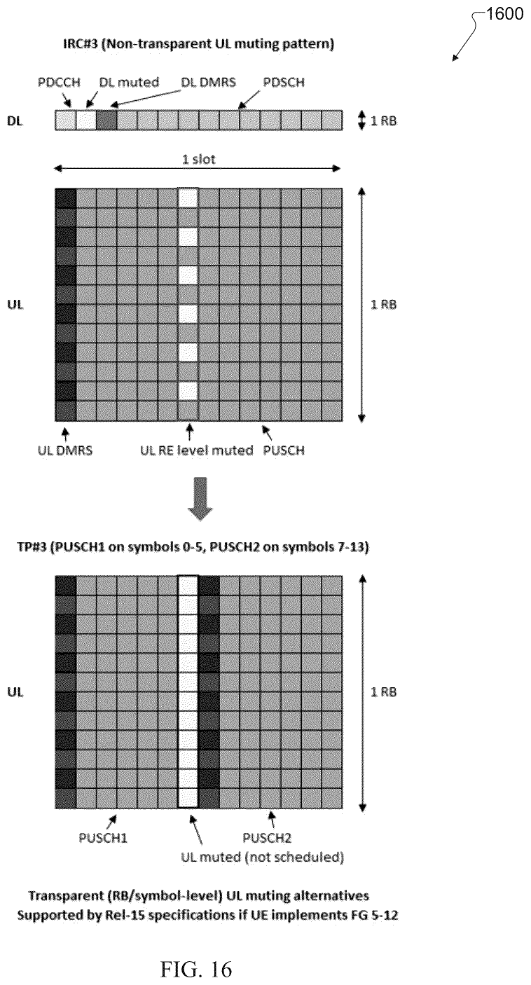

FIG. 16 illustrates a diagram of an example non-transparent resource muting pattern 1600 according to the embodiments of the present disclosure. For example, non-transparent resource muting pattern 1600 can be implemented by the UE 116 of FIG. 3 and the gNB 102 and/or network 130 in the wireless network 100 of FIG. 1. This example is for illustration only and other embodiments can be used without departing from the scope of the present disclosure.

The gNB receiver capabilities can be further improved. For example, it can be expected that the victim gNB (e.g., the BS 103) is able to estimate the gNB-to-gNB interference covariance matrix based on the UL DM-RS. To obtain such estimation, it can be expected that the victim gNB uses a clean channel estimation based on UL DM-RS and subtracts the channel estimation of UL DM-RS contaminated with the inter-gNB CLI. For modeling purposes, this method can be approximated as Wishart distribution. For example, such a type of receiver can be denoted as Wishart e-LMMSE-IRC.

For example, the gNB UL receiver can estimate the gNB CLI interference covariance matrix. The victim gNB can use dedicated resources specifically for such gNB-to-gNB CLI measurements, i.e., SSBs or NZP-CSI-RS from the aggressor gNB (e.g., the BS 102). Note that actual knowledge of the scheduling decision, e.g., PDSCH present/absent on the time-/frequency resources may or may not be necessary to be exchanged between gNBs. The configured time-/frequency locations of the SSB or NZP CSI-RS measurement signals may need to be configured across the gNBs. This may require some form of resource muting, i.e., empty/unoccupied REs or RBs as part of the PUSCH transmission from the UE to the victim gNB but also in the PDSCH transmission from the aggressor gNB (e.g., the BS 102) such that a clean and a contaminated estimate can be obtained by the victim gNB UL receiver. Based on the CLI estimation, the victim gNB UL receiver can then equalize the received UL transmissions as a function of the inter-gNB CLI characteristics in the slot.

If the muting is done at RB/symbol level, it can in principle be handled through the victim gNB scheduling, and is said to be UE transparent. If the muting is done at RE level on PUSCH data symbols, it is said to be UE non-transparent. If the muting is done at RE level on PUSCH DM-RS symbols, such as when CDM groups without data are indicated or configured, the muting may be UE transparent. Specification changes would result to define RE-level muting patterns at least in the PUSCH data symbols. This can impact TB processing at symbol level because different symbols of the same PUSCH allocation can result in a different number of data-carrying REs. In particular this can affect EVM performance of the UE implementation and maximum power reduction (MPR) requirements. To estimate multiple aggressor gNBs, multiple muting patterns may be required.

In the following, several examples are shown to illustrate the principles of gNB UL receiver based on inter-gNB CLI estimation and equalization.

With reference to FIG. 12, a first example for a transparent UL resource muting pattern is shown. The PDCCH is scheduled in the first 2 symbols in a slot within the DL subband and PDSCH is scheduled in the other symbols in this slot. One DL DM-RS is allocated at the 3^{rd} symbol expecting PDSCH mapping Type B. In the UL subband, to measure the covariance matrix of inter-site gNB-gNB co-channel inter-subband CLI on PDCCH and PDSCH, respectively, the PUSCH should be scheduled from the 4^{th} symbol in this slot, where one UL DM-RS is allocated on the 4^{th} symbol since only PUSCH mapping Type B can be used here. In addition, to avoid the effect of inter-site gNB-gNB co-channel inter-subband CLI on the UL DM-RS based channel measurement, the 4^{th} symbol within DL subband is muted by a DL RB-level rate matching resource. Therefore, there are 3 UL muting symbols and 1 DL muting symbol in this pattern.

With reference to FIG. 13, a second example for a transparent UL resource muting pattern is shown. PDCCH is scheduled in the first 3 symbols within the DL subband. Therefore, there are 4 UL muting symbols and 1 DL muting symbol in this pattern.

With reference to FIG. 14, an example for non-transparent resource muting pattern is shown. PDCCH is scheduled in the first 3 symbols in a slot and PDSCH is scheduled form the 5th symbol to the last symbol in this slot in the DL subband. 1 DL DM-RS is allocated at the 5^{th} symbol expecting PDSCH mapping Type B and the 4^{th} symbol is muted to avoid the effect of inter-site gNB-gNB co-channel inter-subband CLI on the UL DM-RS based channel measurement. PUSCH is scheduled over the symbols in the slot of the UL subband. 1 UL DM-RS is allocated in the 4^{th} symbol since only PUSCH mapping Type A can be used here. The 5^{th} symbol is muted to avoid the effect of UE-UE co-channel inter-subband CLI on the DL DM-RS based channel measurement. A comb-2 RE muting is used in the 1^{st} symbol to measure the covariance matrix of inter-site gNB-gNB co-channel inter-subband CLI on the PDCCH. Therefore, there are 1.5 UL muting symbols and one DL muting symbol in this pattern. In addition, it is expected that 3 dB UL power boosting is applied in the 1^{st} symbol to compensate for the loss of comb-2 RE muting.

With reference to FIG. 15 and FIG. 16, several more examples are shown for transparent resource muting pattern such as when a first or a last symbol of the NR slot is muted, respectively, or when a middle symbol of the NR slot is muted. For example, patterns TP #1 and TP #2 create scheduling gaps on the first and the last symbol(s) of the slot. Contiguous PUSCH allocations in time-domain are then limited to 13 symbols at most. For Rel-19 SBFD-aware UEs implementing the (optional) Rel-15 FG 5-12 (up to 2 PUSCHs per slot per CC for different TBs for UE (e.g., the UE 116) processing time capability 1), a scheduling gap can be created in the middle of the slot as shown in the case of pattern TP #3.

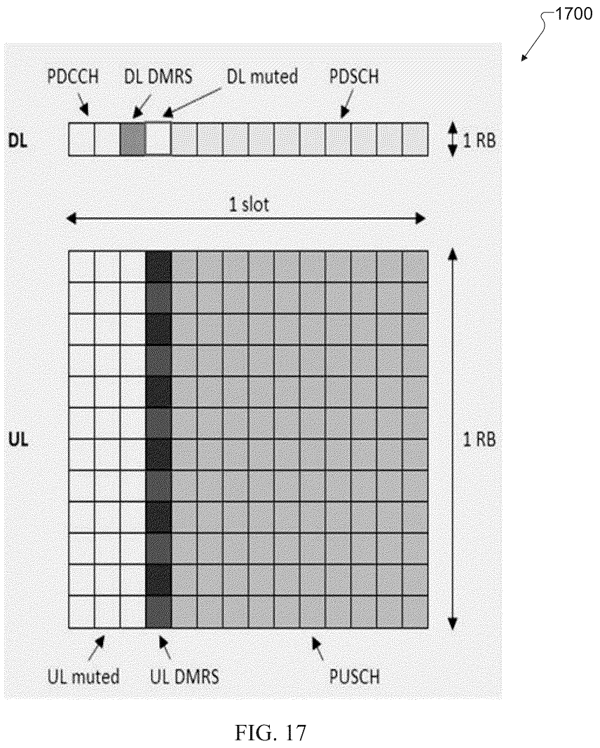

FIG. 17. illustrates a diagram of an example transparent resource muting pattern 1700 according to the embodiments of the present disclosure. For example, transparent resource muting pattern 1700 can be implemented by the UE 115 and the gNB 102 and/or network 130 in the wireless network 100 of FIG. 1. This example is for illustration only and other embodiments can be used without departing from the scope of the present disclosure.

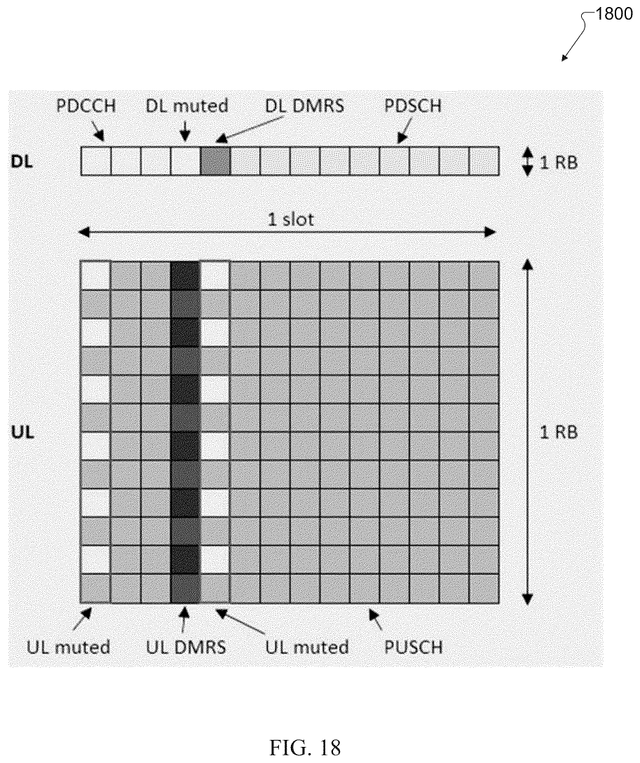

FIG. 18. illustrates a diagram of an example transparent resource muting pattern 1800 according to the embodiments of the present disclosure. For example, transparent resource muting pattern 1800 can be implemented by the UE 116 and the gNB 102 and/or network 130 in the wireless network 100 of FIG. 1. This example is for illustration only and other embodiments can be used without departing from the scope of the present disclosure.

For example, when a resource muting is done with RB or symbol level resolution, i.e., an RB or a symbol or multiples thereof is muted and not used for transmission, a victim gNB (e.g., the BS 102) may allocate such radio resources to the UE through scheduling. For example, this type of resource muting can be said to UE transparent when no change to existing or common NR signal or channel structure is necessary. In another example, when a resource muting is done with RE level resolution, e.g., a RE or more are muted within a PUSCH symbol, this type of resource muting can be said to be UE non-transparent when a change to existing or common NR signal or channel structure is necessary. For example, RE level muting may be UE transparent with respect to existing or an common NR signal structure or channel when taking into account that a PUSCH DM-RS symbol may result in unused REs on the symbol in the PUSCH allocation in cases such as when CDM groups without data are indicated or configured to the UE. For example, to estimate an interfering signal with respect to one or multiple aggressor gNBs, one or multiple resource muting patterns may be used.

With reference to FIG. 17, an example timeline for a transparent UL resource muting pattern for the gNB to measure or estimate a covariance matrix of inter-site gNB-gNB co-channel inter-subband CLI is shown. In the example, a PDCCH is scheduled in the first 2 symbols in a slot within an SBFD DL subband and a PDSCH is scheduled in the other symbols of the slot. A DL DM-RS is allocated to the 3^{rd} symbol in the slot expecting PDSCH mapping Type B. In the SBFD UL subband, a PUSCH is scheduled from the 4^{th} symbol in the slot, and one UL DM-RS is allocated on the 4^{th} symbol for PUSCH mapping Type B. For example, to avoid the effect of co-channel inter-subband CLI on a UL DM-RS based channel measurement, the 4^{th} symbol within the SBFD DL subband is muted by a DL RB-level rate matching resource. In the example, there are 3 full UL muting symbols and 1 full DL muting symbol in this pattern.

With reference to FIG. 18, an example timeline for a non-transparent UL resource muting pattern for the gNB to measure or estimate a covariance matrix of inter-site gNB-gNB co-channel inter-subband CLI is shown. In the example, a PDCCH is scheduled in the first 3 symbols in a slot within an SBFD DL subband and a PDSCH is scheduled starting from the 5^{th} symbols of the slot. A DL DM-RS is allocated to the 5^{th} symbol in the slot expecting PDSCH mapping Type B. In the SBFD UL subband, a PUSCH with mapping type A is scheduled from the 1^{st} symbol in the slot, and one UL DM-RS is allocated on the 4^{th} symbol. The 1^{st} and the 5^{th} PUSCH symbol are muted using a comb-2 muting pattern. For example, a 3 dB UL power boosting may be applied to the non-empty, e.g., not muted REs carrying data and/or control in the 1^{st} and 5^{th} symbols to compensate for the loss from the comb-2 RE muting pattern. In the example, are two comb-2 UL muting symbols and 1 full DL muting symbol in this pattern.

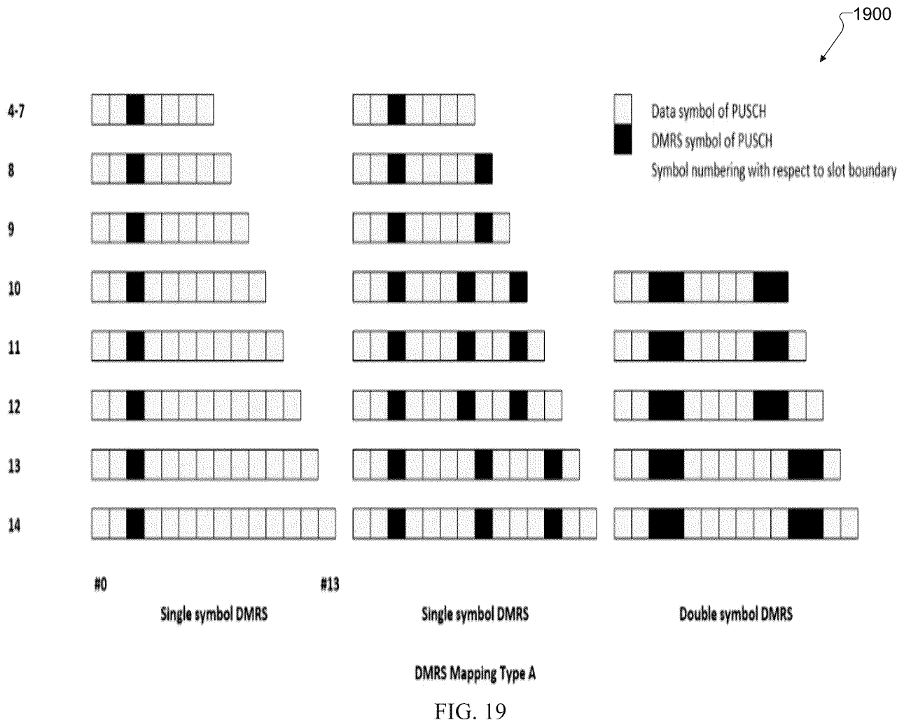

FIG. 19 illustrates a diagram of example DM-RS configurations 1900 according to the embodiments of the present disclosure. For example, DM-RS configurations 1900 can be utilized by any of the UEs 111-116 of FIG. 1, such as the UE 116. This example is for illustration only and other embodiments can be used without departing from the scope of the present disclosure.

With reference to Rel-18 NR specifications, the UE can be provided with a higher layer parameter DM-RS-UplinkConfig indicating to the UE a DM-RS type based on parameter DM-RS-Type such as ‘type1’ or ‘type2’ and/or a DM-RS symbol location based on parameter DM-RS-AdditionalPosition such as ‘pos0’ or ‘pos1’ or ‘pos2’ or ‘pos3’ and/or a maximum number of OFDM symbols for UL front-loaded DM-RS based on parameter maxLength such as ‘len1’ or ‘len2’. For example, a value for DM-RS ‘type1’ or a value for DM-RS symbol location ‘pos2’ or a value for the maximum number of OFDM symbols for UL front-loaded DM-RS ‘len1’ may correspond to a default value which the UE applies if a corresponding field is absent, respectively. Note that other/additional parameters such as DM-RS-TypeEnh may be provided to the UE but are omitted here for conciseness of description. Based on the provided information for a DM-RS type, and/or an DM-RS symbol location, and/or maximum number of front-loaded DM-RS symbols, the UE then determines the PUSCH DM-RS positions within a slot for cases such as a PUSCH mapping type A or B, such as a single-symbol or double-symbol DM-RS, such as an intra-slot frequency-hopping enabled or disabled, and based on a provided DM-RS symbol location according to ‘pos0’, or ‘pos1’, or ‘pos2’, or ‘pos3’ using tabulated system operating specifications according to the details in (REF 1).

With reference to FIG. 19, an example timeline is shown of DM-RS symbol locations in Rel-18 NR for PUSCH Mapping Type A and with respect to some example parameterizations according to the tabulated system operating specifications in (REF 1).

When evaluating UE procedures for transmitting the physical uplink shared channel (PUSCH) in a time-division duplex (TDD) or full-duplex (FD) wireless system where advanced receivers such as based on the principle of CLI estimation and equalization are used, several issues related to limitations and drawbacks of existing technology need to be overcome in order to enable system operation according to channel conditions or to reduce UE modem complexity.

It needs to be taken into account that if non-transparent UL resource muting is supported for interference covariance matrix measurement by the gNB or for gNB-to-gNB CLI measurements, the resulting changes and impact to the UE modem complexity may be high.

A first issue is related to PUSCH processing. For example, when compared to Rel-15 NR operation, additional definition and/or indication of one or more UL resource muting pattern may be needed, insertions or collision handling of an UL muting pattern in presence of other UL signals such as DM-RS or phase tracking reference signal (PTRS) may need to be changed, PUSCH resource mapping may need to be adjusted such as rate-matching around muted REs, TB size determination may need to account for presence of muted REs, or mapping for UCI resources may need to be changed.

However, the number and placement of RE-level UL muting patterns inside a PUSCH transmission can affect the achievable PUSCH demodulation performance in the gNB receiver. The changes and impacts to the UE modem complexity and the achievable PUSCH demodulation performance when supporting non-transparent UL resource muting patterns constitute a trade-off.

A second issue is related to UL transmit power allocations in an OFDM symbol and across OFDM symbols of a PUSCH. For example, support of non-transparent UL resource muting in a PUSCH may result in unequal power allocation across symbols. Muted REs on a symbol can then result in impact to phase continuity across symbols and result in a need to change UE modem processing for PUSCH allocations in presence of UL muting patterns. This is because when power allocations across the REs and the symbols of the PUSCH need to be adjusted to account for the presence of muted REs on some PUSCH symbols, power across partially muted and non-muted symbols needs to be adjusted to preserve equal total power per PUSCH symbol. Therefore, the Tx EPRE of some DM-RS symbols may need to be adjusted with respect to other PUSCH data symbols.

Therefore, embodiments of the present disclosure recognize that there is a need to provide procedures to support non-transparent UL resource muting in UL transmissions to enable gains from gNB advanced receivers such as based on the principle of CLI estimation and equalization while allowing for reduced UE modem complexity and flexibility to adjust system operation according to channel conditions.

In one example, a maximum number J of comb-N muted data symbols or comb-N muted DM-RS symbols or of partially muted data symbol or of partially muted DM-RS symbols for a PUSCH transmission is provided to the UE.

In one example, an allowed time-domain location of a comb-N muted data symbol or a partially muted data symbol is restricted to one of the time-domain locations configurable or indicated for a DM-RS symbol of a PUSCH.

In one example, a transmission parameter associated with a comb-N muted DM-RS symbol or a partially muted DM-RS symbol can be configured or indicated separately from a corresponding transmission parameter configured or indicated for DM-RS symbols in the PUSCH.

In certain embodiments, a comb-N, i.e., N={2, 4 or 8} muted data symbol may refer to a data symbol where every N^{th} resource element (RE) is not used to convey channel coded and/or modulated data. For example, a comb-2 muted data symbol then uses every other subcarrier (SC) to transmit data, while the remaining sub-carriers are zero-power, i.e., no transmission occurs to allow for CLI or channel estimation by the receiver. For example, a comb-4 muted data symbol then mutes every 4^{th} SC but 3 out of N=4 SCs can be used to transmit data in the symbol.

Examples herein are for illustration purposes and generalizes to partially muted data symbols not using regular comb-N structure. For example, a partially muted data symbol may mute a first subset of M1 subcarriers in the symbol and transmit data on a second set subset of M2 subcarriers in the symbol where L=M1+M2 may be suitably selected such as L=12 subcarriers per RB. For example, M1 may correspond to subcarrier indices {1, 3, 4, 5, 9, 10} and M2 may correspond to the subcarrier indices {0, 2, 6, 7, 8, 11}. In this example, half of the subcarriers in the RB are RE level muted but a regular comb-2 structure is not used.

In certain embodiments, a comb-N, i.e., i.e., N={2, 4 or 8} muted DM-RS symbol may refer to an DM-RS symbol where every N^{th} resource element (RE) is not used to convey a known demodulation reference or pilot signal. For example, a comb-2 muted DM-RS symbol then uses every other subcarrier (SC) to transmit the reference signal, while the remaining sub-carriers are zero-power, i.e., no transmission occurs to allow for CLI or channel estimation by the receiver.

Examples herein are for illustration purposes and generalizes to partially muted DM-RS symbols not using regular comb-N structure. For example, a partially muted DM-RS symbol may mute a first subset of M1 subcarriers in the symbol and transmit a reference signal on a second set subset of M2 subcarriers in the symbol where L=M1+M2 may be suitably selected such as L=12 subcarriers per RB. For example, M1 may correspond to subcarrier indices {0, 1, 4, 5, 8, 9} and M2 may correspond to the subcarrier indices {2, 3, 6, 7, 10, 11}. In this example, half of the subcarriers in the RB are RE level muted but a regular comb-2 structure is not used.

For example, a comb-N muted DM-RS symbol or a partially muted DM-RS symbol may correspond to an NR DM-RS type. For example, one or more subsets of muted REs in such a symbol may correspond to one or more CDM groups without data.

Without loss of generality and for illustration purposes, a comb-N muted data symbol or comb-N muted DM-RS symbol, or a partially muted data symbol or a partially muted DM-RS symbol may be used for transmitting and/or receiving PUSCH based on OFDM or DETS-OFDM modulation.

In one example, a maximum number J of comb-N muted data symbols or comb-N muted DM-RS symbols or of partially muted data symbol or of partially muted DM-RS symbols for a PUSCH transmission is provided to the UE. A maximum number J may be associated with and/or restricted by the number N of a comb-N muted data or DM-RS symbol or by the number N of muted REs in a partially muted data or DM-RS symbol.

For example, J=2 for N=2, J=3 for N=3, J=4 for N=4, etc. when comb-N muted data symbols or comb-N muted DM-RS symbols are used. For J=2, the number of available data REs in N=2 muted data symbols then correspond to the number of data REs in one unmuted data symbol. For J=3, the number of available data REs in the N=3 muted data symbols then correspond to the number of data REs in two unmuted data symbols, etc. Similar principles extend to the case where 1/N muted REs are used in a partially muted data symbol or in a partially muted DM-RS symbol, J=2 for N=2.

For example, when resource muting using a comb-N muted data or comb-N muted DM-RS symbol is configured or indicated to the UE, the UE then doesn't expect to be configured or indicated with fewer than or with more than J comb-N muted data or comb-N muted DM-RS symbols. Similar principles extend to the case where 1/N muted REs are used in a partially muted data symbol or in a partially muted DM-RS symbol, J=2 for N=2.

A motivation is that the impact to PUSCH rate-matching can be reduced which decreases UE modem complexity when non-transparent UL resource muting is supported. The number of available data REs in J comb-N muted data symbols then corresponds to an integer number of unmuted data symbols. For example, the number N_RE of available PUSCH resources for transport Block size (TBS) determination or PUSCH mapping is then scalable by an integer number of symbols. Therefore, RE mapping and/or TBS size determination are simplified in the UE implementation.

In one example, an allowed time-domain location of a comb-N muted data symbol or a partially muted data symbol is restricted to one of the time-domain locations configurable or indicated for a DM-RS symbol of a PUSCH.

For example, when a comb-N muted data symbol or a partially muted data symbol corresponding to 1/N unused REs is configured for or indicated to the UE, the allowed time-domain symbol location for such a comb-N muted data symbol or partially muted data symbol corresponds to a configurable or allowed DM-RS symbol position. The comb-N muted data symbol or partially muted data symbol then cannot be allocated to a DM-RS symbol position which is not allowed as by the NR DM-RS RS type, mapping type, and corresponding PUSCH allocation (depending on start symbol and number of PUSCH symbols).

For example, when P comb-N muted data symbol or a partially muted data symbols corresponding to 1/N unused REs are configured for or indicated to the UE, the set of allowed time-domain symbol locations for the comb-N muted data symbol or partially muted data symbol corresponds is a subset of the set Q of configurable or allowed DM-RS symbol positions. For example, when Q=2, then P=1 or P=2 comb-N muted data symbols can only be located in the time-domain location, i.e., on the symbols configured or indicated by the DM-RS configuration for the PUSCH. Without loss of generalization, P<Q or P=Q. When P=Q, the P comb-N muted data symbols are mapped to the set of Q DM-RS positions.

A motivation is that the implementation of UL Tx power levels for the PUSCH transmission in the UE modem can be simplified. Using existing Rel-15 NR, the Tx EPRE and/or symbol power of DM-RS symbols in a PUSCH is adjusted to the data symbols. When comb-N muted data symbols or partially muted data symbols are restricted to the allowed symbol positions of DM-RS symbols as configured or indicated to the UE in the PUSCH, then the time-domain processing of the UE modem implementation is restricted to those symbols corresponding to DM-RS where such an adjustment is already supported.

In one example, a transmission parameter associated with a comb-N muted DM-RS symbol or a partially muted DM-RS symbol can be configured or indicated separately from a corresponding transmission parameter configured or indicated for DM-RS symbols in the PUSCH. For example, a transmission parameter may correspond to an antenna port, CDM group, EPRE value, subcarrier or symbol position.

For example, a comb-N muted DM-RS symbol or a partially muted DM-RS symbol may be configured or indicated to the UE to use a separate higher-layer configuration provided to the UE. For example, a comb-N muted DM-RS symbol or partially muted DM-RS symbol may use a configured port number/layer mapping, or a configured number of layer or a configured precoding. In another example, such a port mapping, layer mapping or precoding can be tabulated and provided to the UE by system specifications.

In another example, the comb-N muted DM-RS symbol or a partially muted DM-RS symbol does not use the indication received in a precoding or antenna port field in an UL grant DCI format such as 0_0, 0_1 or 0_3 when transmitting the comb-N muted DM-RS symbol or the partially muted DM-RS symbol. The UE sets transmission parameters received in a precoding or antenna port field in the UL grant DCI format for the DM-RS symbol.

A motivation is that MIMO operation using the DM-RS symbols for the PUSCH transmissions using non-transparent UL resource muting can be decoupled from the presence and limitations resulting from the comb-N muted DM-RS symbols or partially muted DM-RS symbols. This preserves flexibility of the gNb scheduler to adjust UE operation to channel conditions.

In one embodiment, a value J associated with a number of comb-N muted data symbols for a PUSCH transmission is provided to the UE. The value for J may be associated with a value N for a comb-N muted data symbol. The UE is provided with a condition or a restriction with respect to J based on which UL muting for PUSCH is to be applied and when not to applied by the UE. The UE determines if to apply UL muting for not to apply UL muting for a PUSCH transmission based on the provided number J and/or based on a configured or indicated value N for the comb-N muted data symbol.

In one embodiment, a value Jₘₐₓ associated with a maximum allowed or a maximum number of comb-N muted data symbols for a PUSCH transmission is provided to the UE. The UE determines an actual UL muting pattern for a PUSCH transmission based on a UL muting pattern based on a condition or a restriction with respect to the value Jₘₐₓ. The UE determines a value J of an actual or an applied number of muted data symbols for the PUSCH transmission based on the provided value Jₘₐₓ and/or based on a configured or indicated value N for a comb-N muted data. For example, J may be determined as J≤Jₘₐₓ.

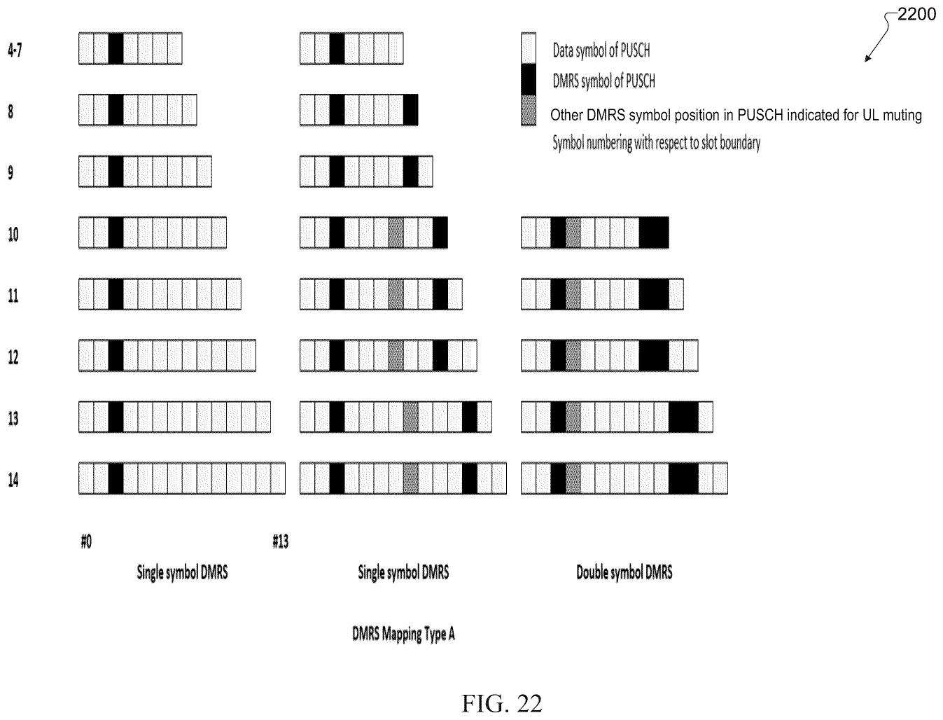

FIG. 22 illustrates a diagram of example DM-RS configurations 2200 according to the embodiments of the present disclosure. For example, DM-RS configurations 2200 can be utilized by any of the UEs 111-116 of FIG. 1, such as the UE 111. This example is for illustration only and other embodiments can be used without departing from the scope of the present disclosure.

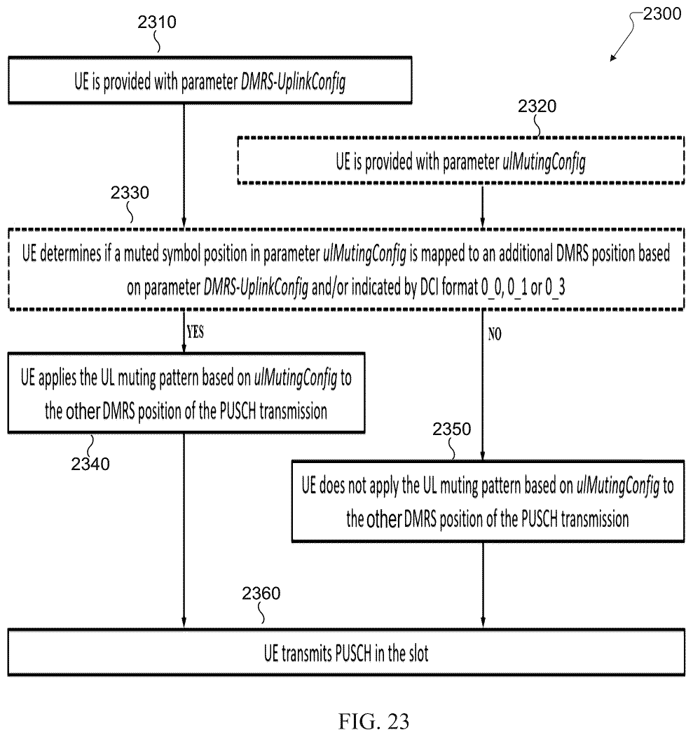

FIG. 23 illustrates a flowchart of an example UE procedure 2300 for applying an UL muting pattern to a PUSCH transmission according to the embodiments of the present disclosure. For example, UE procedure 2300 can be performed by any of the UEs 111-116 of FIG. 1, such as the UE 114. This example is for illustration only and other embodiments can be used without departing from the scope of the present disclosure.

The procedure begins in 2310, a UE is provided with parameter DM-RS-UplinkConfig. In 2320, the UE may be provided with parameter ulMutingConfig. In 2330, the UE determines if a muted symbol position in parameter ulMutingConfig is mapped to an additional DM-RS position based on parameter DM-RS-UplinkConfig and/or indicated by DCI format 0_0, 0_1, or 0_3. If the UE determines that a muted symbol position in parameter ulMutingConfig is mapped to an additional DM-RS position based on parameter DM-RS-UplinkConfig and/or indicated by DCI format 0_0, 0_1, or 0_3, then in 2340, the UE applies the UL muting pattern based on the ulMutingConfig to the other DM-RS position of the PUSCH transmission. If the UE determines that a muted symbol position in parameter ulMutingConfig is not mapped to an additional DM-RS position based on parameter DM-RS-UplinkConfig and/or indicated by DCI format 0_0, 0_1, or 0_3, then in 2350, the UE does not apply the UL muting pattern based on the ulMutingConfig to the other DM-RS position of the PUSCH transmission. In 2360, the UE transmits PUSCH in the slot.

In one embodiment, the UE is provided with a symbol location for an UL muting pattern of a PUSCH transmission in a slot corresponding to a configured or an indicated common PUSCH DM-RS symbol location of the PUSCH.

In one embodiment, the UE is provided with a condition or a restriction associated with a time-domain or symbol location of a comb-N muted symbol on a common DM-RS position for a PUSCH in a slot with respect to a PUSCH transmission format.

In one embodiment, the UE is provided with a first and a second UL transmission parameter, respectively, for a comb-N muted symbol of a PUSCH on a common DM-RS position when the symbol is used to transmit the comb-N muted symbol and for when the symbol is used to transmit a common DM-RS. For example, a separately provided UL transmission parameter for the symbol may correspond to one or more of the following: an antenna port, a CDM group, a Tx EPRE value, a configured transmission power, or a maximum power reduction value, or a closed loop power control process.

In certain embodiments, a comb-N, e.g., N=2, N=4 or N=8, muted data symbol of a PUSCH may refer to a data symbol where every N^{th} resource element (RE) in an RB or every N^{th} RE with respect to a suitably chosen frequency domain reference unit is not used to convey channel coded and/or modulated data or control.

In one example, a comb-2 muted data symbol in an RB may use every other subcarrier (SC) to transmit data. The remaining sub-carriers may correspond to zero-power REs on which no transmission occurs. A half of the REs in the RB is then used by the UE to transmit data or control in the RB and another half of the REs in the RB is not used by the UE to transmit. In another example, a comb-4 muted data symbol may refer to muting every 4^{th} SC in an RB and 3 out of 4 SCs in the RB are used by the UE to transmit data or control.

The examples are chosen for illustration purposes and without loss of generality can be generalized to partially muted data symbols including other example cases such as when an irregular comb-N structure is used or employed for muting in an RB or with respect to a suitably chosen frequency domain reference unit. In one example, in a partially muted data symbol a first subset of M1 subcarriers in the symbol in an RB may be used by the UE to transmit data or control on corresponding REs and a second subset of M2 subcarriers in the symbol in the RB is muted, e.g., the UE doesn't transmit on the second subset of M2 SCs. Here, L=M1+M2 may be suitably selected with respect to a frequency domain reference unit, e.g., L=12 SCs per RB. In the example, M1 may correspond to a first subset of subcarrier indices, e.g., {1, 3, 4, 5, 9, 10} and M2 may correspond to a second subset of subcarrier indices, e.g., {0, 2, 6, 7, 8, 11}. In the example, a half of the subcarriers in the RB are muted but not using a regular comb-2 structure.

In certain embodiments, a comb-N, e.g., N=2, 4 or 8, muted DM-RS symbol may refer to an DM-RS symbol of a PUSCH where every N^{th} RE in an RB or every N^{th} RE with respect to a suitably chosen frequency domain reference unit is not used to transmit a demodulation reference or pilot signal.

In one example, a comb-2 muted DM-RS symbol in an RB may use every other subcarrier (SC) to transmit the demodulation reference or pilot signal. The remaining sub-carriers may correspond to zero-power REs on which the UE does not transmit a demodulation reference or pilot signal.

The example is chosen for illustration purposes and without loss of generality can be generalized to partially muted DM-RS symbols including other example cases such as when an irregular comb-N structure is used or employed for muting in an RB or with respect to a suitably chosen frequency domain reference unit. In one example, in a partially muted DM-RS symbol a first subset of M1 subcarriers in the symbol in an RB may be used by the UE to transmit a reference or pilot signal on corresponding REs and a second subset of M2 subcarriers in the symbol in the RB is muted, e.g., the UE doesn't transmit a reference or pilot signal on the second subset of M2 SCs. Here, L=M1+M2 may be suitably selected with respect to a frequency domain reference unit, e.g., L=12 SCs per RB. In the example, M1 may correspond to a first subset of subcarrier indices, e.g., {0, 1, 4, 5, 8, 9} and M2 may correspond to a second subset of subcarrier indices, e.g., {2, 3, 6, 7, 10, 11}. In the example, a half of the subcarriers in the RB are muted but a regular comb-2 structure is not used.

For example, a comb-N muted DM-RS symbol or a partially muted DM-RS symbol may correspond to a DM-RS type provided by Rel-15 NR specifications. For example, one or more subsets of muted REs in such a symbol may then correspond to one or more CDM groups without data.

In certain embodiments, a comb-N muted data symbol or a comb-N muted DM-RS symbol, or a partially muted data symbol or a partially muted DM-RS symbol may be used for transmission of an UL signal or channel by the UE. For example, an UL transmission by the UE may correspond to a PUSCH using OFDM or DETS-OFDM modulation.

Throughout the disclosure, the term ‘UL muting” is used as a short form for “not transmitting on a set of REs in a set of RBs on one or more symbols of a PUSCH transmission wherein the PUSCH allocation in time- and/or frequency domain is otherwise mostly expected to be contiguous in absence of UL muting”. With reference to Rel-15 NR and in frequency-domain, for example PUSCH resource allocation type 0 can be used. A contiguous block of RBs may be allocated to the UE using a Resource Indication Value (RIV) associated with a starting RB and a number of contiguous RBs for the PUSCH allocation. “Mostly contiguous” then can mean that with few exceptions such as REs corresponding to CDM groups without data on a DM-RS symbol, the REs over the PUSCH allocation bandwidth would be used to transmit data or control or reference/pilot signals in absence of UL muting. In another example, using PUSCH resource allocation type 1, resources may be assigned in groups of RBs called RBGs, and a bitmap may be used to indicate which RBGs the UE should use for the PUSCH transmission. “Mostly contiguous” then can mean, per contiguous segments or per cluster of the PUSCH allocation. Similar evaluations can be extended to time-domain. With reference to Rel-15 and in time-domain, a number of contiguous symbols corresponding to a PUSCH allocation in a slot may be indicated to the UE based on a time-domain resource allocation (TDRA) table and/or TDRA field in a DCI. “Mostly contiguous” then may refer to a number of consecutive symbols in the PUSCH allocation. The terms ‘UL muting’, “UL resource muting”, or “resource muting”, or ‘comb-N muting’ may be used interchangeably in the disclosure.

In certain embodiments, the term “UL muting pattern” is used as short form for a set of muted REs in a set of RBs on one or more symbols of PUSCH allocation”. A UE may be provided with a configuration of UL muting or an UL muting pattern for a PUSCH based on a higher layer parameter ulMutingConfig. For example, the UE may be provided with a parameter such as a value for N, e.g., N=2, or a value for a comb offset M on a symbol with respect to a subcarrier index 0, or a set of L symbols associated with the symbols of a PUSCH time-domain allocation on which a comb-N muting pattern may be applied. For example, multiple values or multiple sets for parameter ulMutingConfig may be provided to the UE.

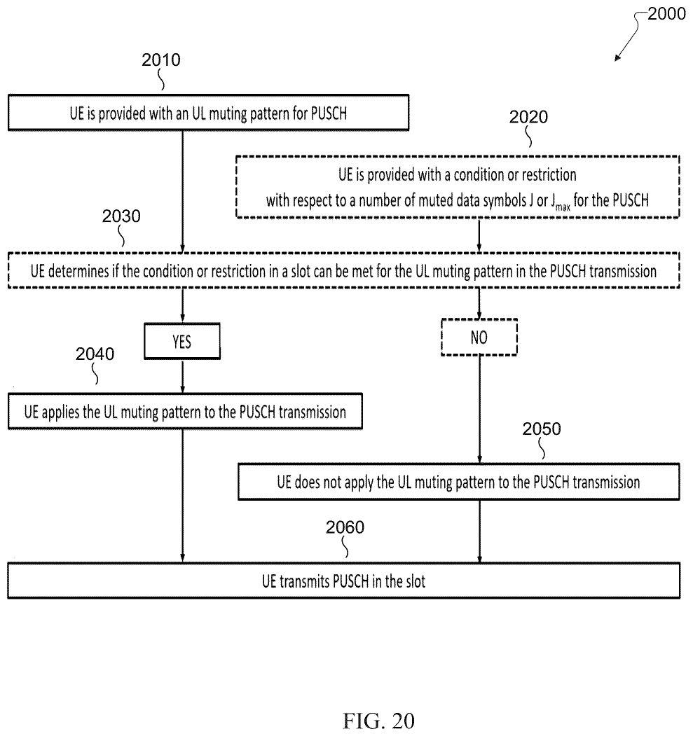

FIG. 20 illustrates a flowchart of an example UE procedure 2000 for applying an UL muting pattern to a PUSCH transmission according to the embodiments of the present disclosure. For example, procedure 2000 can be performed by any of the UEs 111-116 of FIG. 1, such as the UE 112. This example is for illustration only and other embodiments can be used without departing from the scope of the present disclosure.

The procedure begins in 2010, a UE is provided with an UL muting pattern for PUSCH. In 2020, the UE may be provided with a condition or restriction with respect to a number of muted data symbols J or Jₘₐₓ for the PUSCH. In 2030, the UE determines if the condition or restriction in a slot can be met for the UL muting pattern in the PUSCH transmission. If the UE determines that the condition or restriction in a slot can be met for the UL muting pattern in the PUSCH transmission, then in 2040, the UE applies the UL muting pattern to the PUSCH transmission. If the UE determines that the condition or restriction in a slot cannot be met for the UL muting pattern in the PUSCH transmission, then in 2050, the UE does not apply the UE muting pattern to the PUSCH transmission. In 2060, the UE transmits the PUSCH in the slot.

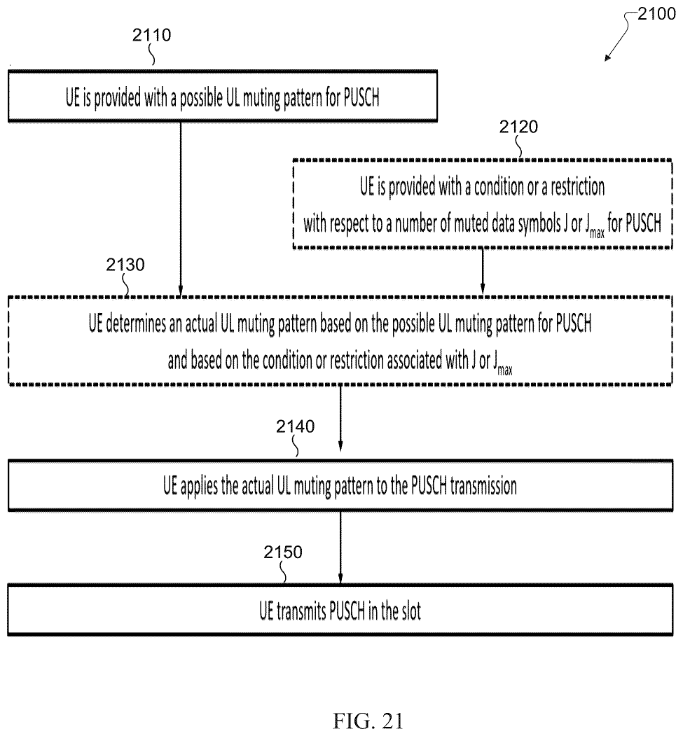

FIG. 21 illustrates a flowchart of an example UE procedure 2100 for applying an UL muting pattern to a PUSCH transmission according to the embodiments of the present disclosure. For example, procedure 2100 can be performed by any of the UEs 111-116 of FIG. 1, such as the UE 113. This example is for illustration only and other embodiments can be used without departing from the scope of the present disclosure.

The procedure begins in 2110, a UE is provided with a possible UL muting pattern for PUSCH. In 2120, the UE may be provided with a condition or a restriction with respect to a number of muted data symbols J or Jₘₐₓ for the PUSCH. In 2130, the UE determines an actual UL muting pattern based on the possible UL muting pattern for PUSCH and based on the condition or restriction associated with J or Jₘₐₓ. In 2140, the UE applies the actual UL muting pattern to the PUSCH transmission. In 2150, the UE transmits PUSCH in the slot.

In one embodiment, a value J associated with a number of comb-N muted data symbols for a PUSCH transmission is provided to the UE. The value for J may be associated with a value N for a comb-N muted data symbol. The UE is provided with a condition or a restriction with respect to J based on which UL muting for PUSCH is to be applied and when not to applied by the UE. The UE determines if to apply UL muting for not to apply UL muting for a PUSCH transmission based on the provided number J and/or based on a configured or indicated value N for the comb-N muted data symbol.

In a variant, a value J can be associated with a number of comb-N muted data symbols, and/or with a number of comb-N muted DM-RS symbols, and/or with a number of partially muted data symbols, and/or or with a number of partially muted DM-RS symbols for a PUSCH transmission may be provided to the UE. The UE determines if to apply UL muting or not to apply UL muting for a PUSCH transmission based on the provided number J and/or based on the number of comb-N muted data symbols, and/or the number of comb-N muted DM-RS symbols, and/or the number of partially muted data symbols, and/or or the number of partially muted DM-RS symbols for a PUSCH transmission.

For example, J=2 for N=2, J=3 for N=3, J=4 for N=4, etc. when comb-N muted data symbols are used in every RB of a PUSCH frequency allocation. In one example, for J=2, the number of available data REs in the comb-2 muted data symbols then correspond to the number of data REs in one unmuted data symbol. In another example, for J=3, the number of available data REs in the comb-3 muted data symbols then correspond to the number of data REs in two unmuted data symbols, etc. Similar principles can be extended to other cases such as when a partially, regular comb or irregular comb muted data symbol or muted DM-RS symbol is used, e.g., when N muted REs and N_{SC}^{RB}−N unmuted REs in an RB on a symbol are available in the partially muted data or the muted DM-RS symbol and where NRB N_{SC}^{RB} may correspond to a number of subcarriers per resource block.

In one example, when UL muting based on a comb-2 muted data symbol for a PUSCH transmission is configured or indicated to the UE for a number J of muted data symbols, the UE then doesn't expect to be configured or indicated with less than or with more than J=2 comb-2 muted data symbols. In another example, when UL muting based on a comb-3 muted data symbol for a PUSCH transmission is configured or indicated to the UE for a number J of muted data symbols, the UE then doesn't expect to be configured or indicated with less than or with more than J=3 comb-3 muted data symbols.

Similar principles can be extended to other cases such as when a partially, regular comb or irregular comb muted data symbol or muted DM-RS symbol is used, or cases such as when UL muting is not applied on a symbol in every RB of the PUSCH frequency-domain allocation.

In one embodiment, a value Jₘₐₓ associated with a maximum allowed or a maximum number of comb-N muted data symbols for a PUSCH transmission is provided to the UE. The UE determines an actual UL muting pattern for a PUSCH transmission based on a UL muting pattern based on a condition or a restriction with respect to the value Jₘₐₓ. The UE determines a value J of an actual or an applied number of muted data symbols for the PUSCH transmission based on the provided value Jₘₐₓ and/or based on a configured or indicated value N for a comb-N muted data. For example, J may be determined as J& Jₘₐₓ.

In a variant, a value Jₘₐₓ associated with a maximum allowed or a maximum number of muted data symbols, and/or with a number of comb-N muted DM-RS symbols, and/or with a number of partially muted data symbols, and/or or with a number of partially muted DM-RS symbols for a PUSCH transmission may be provided to the UE. The UE determines a value J of an actual or an applied number of muted data symbols for the PUSCH transmission based on the provided value Jₘₐₓ and/or based on a configured or indicated value for N of the comb-N muted data symbols, and/or the number of comb-N muted DM-RS symbols, and/or the number of partially muted data symbols, and/or or the number of partially muted DM-RS symbols for a PUSCH transmission.

In one example, the UE may be provided with a maximum allowed number Jₘₐₓ=3 for a PUSCH transmission based on comb-N muted data symbols. When the UE receives an UL grant or when the UE is provided with a configured UL grant for a PUSCH transmission with UL muting, the UE determines the actual number of muted data symbols in the PUSCH transmission with UL muting based on a provided maximum allowed number Jₘₐₓ of muted data symbols. For example, if a value N=2 is indicated or configured for the UE in the PUSCH transmission with UL muting on a symbol in every RB of the PUSCH frequency allocation, e.g., using a comb-2 muted data symbol, the UE determines J≤Jₘₐₓ as J=2, as a smallest number of muted symbols J for a number of comb-2 muted data symbols in a PUSCH transmission resulting in an equivalent integer multiple number of unmuted data symbols in the PUSCH. For example, if a value N=3 is indicated or configured for the UE in the PUSCH transmission with UL muting on a symbol in every RB of the PUSCH frequency allocation, e.g., using a comb-3 muted data symbol, the UE determines J≤Jₘₐₓ as J=3, as a smallest number of muted symbols J for a number of comb-3 muted data symbols in a PUSCH transmission resulting in an equivalent integer multiple number of unmuted data symbols in the PUSCH.

Similar principles can be extended to other cases such as when a partially, regular comb or irregular comb muted data symbol or muted DM-RS symbol is used, or cases such as when UL muting is not applied on a symbol in every RB of the PUSCH frequency-domain allocation.

In one embodiment, a value J associated with a number of comb-N muted data symbols or a value Jₘₐₓ associated with a maximum allowed or a maximum number of comb-N muted data symbols for a PUSCH transmission is provided to the UE. The UE selects an actual UL muting pattern from a set of UL muting patterns for a PUSCH transmission based on a condition or a restriction with respect to the value(s) J or Jₘₐₓ.

In one example, the UE may be provided with a maximum allowed number Jₘₐₓ=4 for a PUSCH transmission based on comb-N muted data symbols. Without loss of generality and for illustration purposes, the example expects a PUSCH configuration using DM-RS type 1 wherein the UE is provided with a higher layer parameter maxLength set equal to ‘len2’, e.g., using a double symbol DM-RS if the associated DCI or configured grant configuration indicates accordingly. When the UE receives an UL grant or when the UE is provided with a configured UL grant for a PUSCH transmission with UL muting, the UE selects an actual number of muted data symbols in the PUSCH transmission with UL muting based on a provided maximum allowed number Jₘₐₓ of muted data symbols. For example, if a value N=2 is indicated or configured for the UE in the PUSCH transmission with UL muting on a symbol in every RB of the PUSCH frequency allocation, e.g., using a comb-2 muted data symbol, and if no data mapping to an DM-RS symbol is indicated or configured, e.g., for REs on DM-RS symbol(s) not corresponding to CDM groups without data, the UE selects J≤Jₘₐₓ as J=2, as a smallest number of muted symbols J for a number of comb-2 muted data symbols in a PUSCH transmission resulting in an equivalent integer multiple number of unmuted data symbols in the PUSCH, and the UE selects J≤Jₘₐₓ as J=4 as a smallest number of muted symbols J for a number of comb-2 muted data symbols and a number of DM-RS symbols where data REs can be mapped in a PUSCH transmission resulting in an equivalent integer multiple number of unmuted data symbols and/or DM-RS symbols in the PUSCH.

Similar principles can be extended to other cases such as when a partially, regular comb or irregular comb muted data symbol and/or muted DM-RS symbol are used, or cases such as when UL muting is not applied on a symbol in every RB of the PUSCH frequency-domain allocation, or cases such as DM-RS type 2.

A motivation for a condition or a restriction associated with a value J or Jₘₐₓ for a number of muted symbols of a PUSCH transmission with UL muting is that computational and/or implementation complexity can be reduced for a gNB (e.g., the BS 102) and/or UE modem design. For example, when UL muting for PUSCH can be applied such that a determination or selection of J can result in a resulting number of data REs associated with an equivalent integer number of unmuted data symbols, a number N_{RE} of available resource elements in a PUSCH transmission can result in an integer multiple number of unmuted data symbols. Correspondingly, modem processes such as a TBS size determination and/or RE mapping of a PUSCH transmission and reception may be simplified in the UE or gNB implementation.

A number J or Jₘₐₓ can be suitably selected according to a number of criteria other than a criterion to result in an equivalent integer number of unmuted data symbols. For example, a value for J or Jₘₐₓ may be suitably selected such that a resulting number of muted data symbols in-between two DM-RS symbol or DM-RS symbol groups does not exceed a maximum number. A motivation may be to avoid power imbalance and/or phase discontinuities in the transmitter chain.

A value for J or Jₘₐₓ may be provided to the UE associated with a condition or a restriction based on which UL muting for PUSCH is to be applied and when not to applied by the UE. For example, the condition or restriction associated with UL muting with respect to the number J or Jₘₐₓ of comb-N muted data symbols may be provided, configured or indicated to the UE based on one of or a combination of DCI-based signaling, L1 control signaling, RRC signaling, or MAC CE based signaling.

For example, a value J or Jₘₐₓ may be provided to the UE by higher layers by a parameter associated with a condition or restriction associated with the UL muting, e.g., a condition or a restriction subject to which the UL muting in a PUSCH transmission may be applied or not applied. For example, a DCI-based indication may be used by the UE to determine if a condition or a restriction with respect to the value J or Jₘₐₓ associated with UL muting for PUSCH may be applied or not. For example, a condition or restriction with respect to the value J or Jₘₐₓ associated with UL muting may be tabulated and/or listed by system operating specifications. A configuration for UL muting on PUSCH may be provided by higher layers to the UE with respect to the value J or Jₘₐₓ and used in conjunction with DCI-based indication by the UE to determine an UL muting pattern for PUSCH with respect to the value J or Jₘₐₓ. If a same condition or restriction with respect to the value J or Jₘₐₓ associated with UL muting is provided for multiple UEs, a common DCI or common RRC signaling message may be used. A UE-specific DCI or RRC signaling of dedicated or common type may be used to provide a condition or a restriction with respect to the value J or Jₘₐₓ associated with UL muting to a UE. A value or a set of values corresponding to a condition or a restriction with respect to the value J or Jₘₐₓ may be provided by a parameter for UL muting on a PUSCH. For example, a UE may select or determine an actual value for J or Jₘₐₓ from the set of values for J associated with a condition or a restriction for UL muting. For example, a value for J or a set of values for J or Jₘₐₓ may be provided based on an index value indicated through a DCI format or through MAC-CE signaling wherein the UE selects from one or more entries provided in an RRC configurable table associated with an index value. The UE may determine a default condition or restriction with respect to the value for J or Jₘₐₓ associated with UL muting for a PUSCH.

In one example, a condition or restriction for J or Jₘₐₓ associated with UL muting for PUSCH is provided to the UE using higher layer signaling. For example, a UE (e.g., the UE 116) may be provided with a configuration of UL muting or an UL muting pattern for a PUSCH including a value for J or Jₘₐₓ based on a parameter ulMutingConfig including the condition or the restriction.

For example, a PUSCH configuration in a higher layer parameter ServingCellConfig or PUSCH-Config may be provided to the UE by higher layers and include a parameter associated with UL muting, e.g., such as to indicate a set of symbols of a PUSCH allocation on which to apply UL muting, and/or a condition or restriction with respect to J or Jₘₐₓ for the UL muting in a PUSCH allocation.

For example, a PUSCH time-domain resource allocation (TDRA) table may be configured for the UE by higher layers and include a parameter associated with J or Jₘₐₓ for a set of symbols of a PUSCH allocation with UL muting. For example, the PUSCH time-domain resource allocation table may be configured for the UE by higher layers and include a parameter associated with a condition or restriction with respect to J or Jₘₐₓ for a PUSCH allocation with UL muting, e.g., for a row of the PUSCH TDRA table or as a parameter provided in the configuration for the PUSCH TDRA table. For example, the UE may be indicated an entry of a PUSCH time-domain resource allocation table associated with J or Jₘₐₓ for a PUSCH allocation with UL muting for indication to the UE based on a TDRA field in a DCI format. For example, a PUSCH transmission with UL muting based on a TDRA table for a configured grant may provide a condition or restriction for J or Jₘₐₓ for a PUSCH with UL muting to the UE.

In one example, information may be provided to the UE by higher layers to associate a DL or UL reference signal or a DL or an UL or joint TCI state(s) or RS resource index(es) such as corresponding to an SSB or to a CSI-RS resource index with a condition or restriction with respect to J or Jₘₐₓ for UL muting on PUSCH. For example, a first TCI state may correspond to a PUSCH transmission with UL muting associated with a first value for J or Jₘₐₓ, and a second TCI state may correspond to a PUSCH transmission with UL muting associated with a second value for J or Jₘₐₓ.

In one example, the UE determines the presence or absence of UL muting for a scheduled or configured PUSCH transmission in a slot based on a provided UL muting pattern and based on a provided condition or restriction with respect to J or Jₘₐₓ. When the condition is met or the restriction is not valid, e.g., when the UE can determine a valid number J of muted data symbols, the UE applies the UL muting pattern to one or more REs of one or more indicated symbols of the PUSCH transmission in the slot, else the UE does not apply the UL muting pattern to the PUSCH and transmits the PUSCH in the slot, or the UE may drop or defer the PUSCH transmission in the slot.

In one example, the UE selects an actual UL muting pattern for a scheduled or configured PUSCH transmission in a slot based on a set of provided UL muting patterns and based on a condition or restriction with respect to J or Jₘₐₓ. When the condition is met or the restriction is not valid, the UE selects an actual UL muting pattern from the set of UL muting patterns and applies the selected UL muting pattern as the actual UL muting pattern to one or more REs of one or more indicated symbols of the PUSCH transmission in the slot, else when the UE cannot determine a valid number J of muted data symbols, the UE does not apply an UL muting pattern to the PUSCH and transmits the PUSCH in the slot, or the UE may drop or defer the PUSCH transmission in the slot. When more than one UL muting patterns for the PUSCH meet the condition with respect to J or Jₘₐₓ or are not precluded by the restriction, a suitably selected rule can be applied to select one of the qualifying UL muting patterns as an actual UL muting pattern for the PUSCH transmission. For example, a first indexed or configured UL muting pattern may then be further selected, or a priority level may be applied to select an UL muting pattern, or an UL muting pattern resulting in a smallest or a largest number of occupied symbols by the UL resource muting may be selected.

In one example, the UE determines an actual UL muting pattern for a scheduled or configured PUSCH transmission in a slot based on a provided UL muting pattern and based on a condition or restriction with respect to J or Jₘₐₓ. When the condition is met or the restriction is not valid, the UE determines the actual UL muting pattern based on parameters associated with the provided UL muting pattern and using the condition or the restriction with respect to J or Jₘₐₓ. The UE adjusts one or more parameters of the UL muting pattern according to the condition or restriction with respect to J or Jₘₐₓ to determine the actual UL muting pattern. Alternatively, the UE may determine that an actual UL muting pattern may not be adjusted or derived based on the provided UL muting pattern while meeting the condition or restriction with respect to J or Jₘₐₓ. When a valid or applicable or allowed actual UL muting pattern can be determined by the UE with respect to J or Jₘₐₓ, the UE applies the actual UL muting pattern to one or more REs on one or more symbols of the PUSCH transmission in the slot, else the UE may not apply an UL muting pattern and transmit the PUSCH without UL muting pattern in the slot, or the UE may drop or defer the PUSCH transmission in the slot. When multiple valid or applicable or allowed actual UL muting patterns with respect to J or Jₘₐₓ result or when multiple UL muting patterns are provided to the UE, a suitably selected rule can be applied to further select one of the qualifying actual UL muting patterns for the PUSCH transmission with respect to J or Jₘₐₓ. For example, a first indexed or configured UL muting pattern may then be further selected, or a priority level may be applied to select an UL muting pattern, or an UL muting pattern resulting in a smallest or a largest number of occupied symbols by the UL resource muting may be selected.

In one embodiment, the UE is provided with a symbol location for an UL muting pattern of a PUSCH transmission in a slot corresponding to a configured or an indicated common PUSCH DM-RS symbol location of the PUSCH.

For example, the UE may be provided with a higher layer parameter DM-RS-UplinkConfig indicating to the UE a DM-RS type based on parameter DM-RS-Type such as ‘type1’ or ‘type2’ and/or a DM-RS symbol location based on parameter DM-RS-AdditionalPosition such as ‘pos0’ or ‘pos1’ or ‘pos2’ or ‘pos3’ and/or a maximum number of OFDM symbols for UL front-loaded DM-RS based on parameter maxLength such as ‘len1’ or ‘len2’ for a PUSCH transmission. For example, a value for DM-RS ‘type1’ or a value for DM-RS symbol location ‘pos2’ or a value for the maximum number of OFDM symbols for UL front-loaded DM-RS ‘len1’ may correspond to a default value which the UE applies if a corresponding field is absent, respectively. Note that other/additional parameters such as DM-RS-TypeEnh may be provided to the UE for a PUSCH transmission but are omitted here for conciseness of description. Based on the provided information for a DM-RS type, and/or an DM-RS symbol location, and/or maximum number of front-loaded DM-RS symbols, the UE determines the PUSCH DM-RS positions within a slot for cases such as a PUSCH mapping type A or B, such as a single-symbol or double-symbol DM-RS, such as an intra-slot frequency-hopping enabled or disabled, and based on a provided DM-RS symbol location according to ‘pos0’, or ‘pos1’, or ‘pos2’, or ‘pos3’ using tabulated system operating specifications according to the details in (REF 1). The UE may be provided with a configuration for an UL muting pattern for a PUSCH based on a higher layer parameter ulMutingConfig. For example, parameter ulMutingConfig may provide information on a time-domain symbol allocation for a muted symbol in a PUSCH allocation corresponding to a configured or indicated common PUSCH DM-RS symbol location of the PUSCH.

With reference to FIG. 22, an example timeline is shown of a muting pattern configuration for a PUSCH for UL muting on common DM-RS positions. In the example, intra-slot frequency-hopping is not enabled, and common PUSCH DM-RS symbol locations or positions are provided to the UE for the case of PUSCH Mapping Type A, for single symbol DM-RS, and for parameter DM-RS-AdditionalPosition set to ‘pos2’ (middle part of FIG. 22), and for PUSCH Mapping type A, for double symbol DM-RS, and for parameter DM-RS-AdditionalPosition set to ‘pos1’ (right part of FIG. 22). The UE does not transmit UL DM-RS on a common PUSCH DM-RS location or position indicated as time-domain symbol location provided by parameter ulMutingConfig; and the UE may transmit the UL DM-RS on a symbol location or position not indicated or configured by parameter ulMutingConfig.

A motivation for using a common DM-RS symbol position for UL transmission of a comb-N muted symbol of a PUSCH with UL muting is that UE modem complexity can be reduced and transmission and reception performance be improved. For example, using existing Rel-15 NR, the Tx EPRE and/or symbol power of DM-RS symbols in a PUSCH is adjusted to the data symbols. Phase consistency across REs and symbols are adjusted. When the symbol location of a comb-N muted symbol is restricted to an allowed symbol position of a common DM-RS symbols in the PUSCH, a time-domain processing of the UE modem implementation is restricted to those common symbols where such functionality and need for adjustment is already supported. For example, a same transmitter filtering may be employed. Another motivation is that for any OFDM symbol that carriers DM-RS of the PUSCH, a parameter Φₗ^{UCI}=Ø, i.e., a UE implementation does not account for a number of available REs on a common DRMS symbol to determine a number of available REs for UCI when multiplexing control and data in the PUSCH. Correspondingly, modem processes such as a UCI (de-)multiplexing in presence of UL muting on PUSCH can be simplified in the UE or gNB implementation.

In one embodiment, the UE is provided with a condition or a restriction associated with a time-domain or symbol location of a comb-N muted symbol on a common DM-RS position for a PUSCH in a slot.

In one example, a condition or a restriction may correspond to a minimum number TH for the number S of a PUSCH time-domain allocation in a slot. The UE applies an actual UL muting pattern on a common DM-RS position to the PUSCH transmission in the slot when the number S of symbols which is indicated or provided to the UE for the PUSCH time-domain allocation in the slot is equal to or larger than the minimum number TH, otherwise the UE does not apply the UL muting pattern on a common DM-RS position to the PUSCH transmission in the slot.

In one example, a condition or a restriction may correspond to a maximum number TH for the number of symbols S of a PUSCH time-domain allocation in a slot. The UE applies an actual UL muting pattern on a common DM-RS position to the PUSCH transmission in the slot when the number S of symbols which is indicated or provided to the UE for the PUSCH time-domain allocation in the slot is equal to or less than the maximum number TH, otherwise the UE does not apply the UL muting pattern on a common DM-RS position to the PUSCH transmission in the slot.

In one example, a condition or a restriction may correspond to a range from TH1 to TH2 for the number of symbols S of a PUSCH time-domain allocation in a slot. The UE applies an actual UL muting pattern on a common DM-RS position to the PUSCH transmission in the slot when the number S of symbols which is indicated or provided to the UE for the PUSCH time-domain allocation in the slot is equal to or greater than TH1 and less than or equal to TH2, otherwise the UE does not apply the UL muting pattern on a common DM-RS position to the PUSCH transmission in the slot.

In one example, a condition or a restriction may correspond to a minimum starting symbol number TH for the first symbol number S of a PUSCH time-domain allocation in a slot. The UE applies an actual UL muting pattern on a common DM-RS position to the PUSCH transmission in the slot when the first symbol number S of the PUSCH transmission in the slot which is indicated or provided to the UE for the PUSCH time-domain allocation in the slot is equal to or larger than the starting symbol number TH, otherwise the UE does not apply the UL muting pattern on a common DM-RS position to the PUSCH transmission in the slot.

In one example, a condition or a restriction may correspond to a maximum end symbol number TH for the last symbol number T of a PUSCH time-domain allocation in a slot. The UE applies an actual UL muting pattern on a common DM-RS position to the PUSCH transmission in the slot when the last symbol number T of the PUSCH transmission in the slot which is indicated or provided to the UE for the PUSCH time-domain allocation in the slot is equal to or less than the end symbol number TH, otherwise the UE does not apply the UL muting pattern on a common DM-RS position to the PUSCH transmission in the slot.

In one example, a condition or a restriction may correspond to a range from TH1 to TH2 for the first and last symbol numbers S and T, respectively, of a PUSCH time-domain allocation in a slot. The UE applies an actual UL muting pattern on a common DM-RS position to the PUSCH transmission in the slot when the first symbol S which is indicated or provided to the UE for the PUSCH time-domain allocation in the slot is equal to or greater than TH1 and when the last symbol number T in the PUSCH time-domain allocation of the slot is less than or equal to TH2, otherwise the UE does not apply the UL muting pattern on a common DM-RS position to the PUSCH transmission in the slot.

In one example, a condition or a restriction associated with UL muting on a common DM-RS position for a PUSCH transmission in a slot corresponds to an allowed or dis-allowed simultaneous UL signal or channel transmission in the slot. For example, when UL muting on a common DM-RS position on a PUSCH in a slot is not allowed if an SRS transmission from the UE occurs in the slot, the UE does not apply the UL muting pattern on a common DM-RS position to the PUSCH transmission in the slot and transmits the PUSCH. When UL muting on a common DM-RS position on a PUSCH is allowed in a slot if an SRS transmission occurs in the slot, the UE applies the UL muting pattern on a common DM-RS position to the PUSCH transmission in the slot and transmits the PUSCH. An allowed or dis-allowed simultaneous UL signal or channel transmission on a common DM-RS position in a slot where UL muting for PUSCH may occur may be provided with respect to another PUSCH transmission, or a PUCCH transmission, or an SRS, or a PRACH transmission in the slot. A suitably selected time-domain gap value may be expected by the UE, e.g., tabulated or specified in system operating specifications. or may be provided to the UE for the simultaneous UL signal or channel transmission in the slot. For example, a minimum time-domain gap value of S=2 symbols may be expected by the UE for support of a PUSCH with UL muting on a common DM-RS position when to be transmitted in a slot with respect to a preceding or a following SRS transmission in the slot.

In one example, a condition or a restriction associated with UL muting on a common DM-RS position for PUSCH may be provided as set of allowed or dis-allowed symbols/slots. For example, a set of symbol/slot identifiers, e.g., a bitmap, or a list of symbols/slots, or a resource indicator value such as start and length indicator value (SLIV) with starting slot/symbol value and a run length value in an index representation may be used to indicate or configure the UE with allowed or dis-allowed symbols/slots for UL muting on a common DM-RS position. For example, when UL muting on a common DM-RS position for a PUSCH in a slot is allowed if the PUSCH transmission is indicated or configured in an allowed set of slots {1, 2}, where slot indices may start with slot index 0, the UE then applies the UL muting pattern on a common DM-RS position to the PUSCH transmission in the slot and transmits the PUSCH. For example, when UL muting on a common DM-RS position on a PUSCH in a slot is not allowed if a PUSCH transmission is indicated or configured in a dis-allowed set of slots {3, 4}, the UE does not apply the UL muting pattern on a common DM-RS position to the PUSCH transmission in the slot and transmits the PUSCH.

In one embodiment, the UE is provided with a condition or a restriction associated with a time-domain or symbol location of a comb-N muted symbol on a common DM-RS position for a PUSCH in a slot with respect to a PUSCH transmission format.

For example, a PUSCH transmission format may correspond to one or a combination of the following: a PUSCH mapping type, a DM-RS type, a frequency hopping enabled or disabled, a number of FL DM-RS symbols, an additional DM-RS position, an RB allocation for PUSCH, a symbol allocation for PUSCH, a modulation scheme for PUSCH, a modulation order or MCS or TBS for PUSCH, a channel coding type or rate for PUSCH, a payload type such as data or UCI/control on PUSCH, or a UCI/control payload type such as A/N, or CSI, or CSI part 1, or CSI part 2, or a UCI/control reporting type such as periodic, or semi-persistent, or aperiodic CSI report in the control payload of a PUSCH, an antenna port, or a CDM group for PUSCH.

In one example, a condition or a restriction associated with UL muting on a common DM-RS position for PUSCH may correspond to a PUSCH mapping type for a PUSCH transmission in a slot. For example, the UE applies an actual UL muting pattern on a common DM-RS position to the PUSCH transmission in the slot when PUSCH mapping type A is configured or indicated in the slot, otherwise, e.g., when PUSCH mapping type B is configured or indicated, the UE does not apply the UL muting pattern to the PUSCH transmission in the slot.

In one example, a condition or a restriction associated with UL muting on a common DM-RS position for PUSCH may correspond to a DM-RS or reference signal type for a PUSCH transmission in a slot. For example, the UE applies an actual UL muting pattern on a common DM-RS position to the PUSCH transmission in the slot when DM-RS type 1 is configured or indicated in the slot, otherwise, e.g., when DM

In one example, a condition or a restriction associated with UL muting on a common DM-RS position for PUSCH may correspond to additional DM-RS positions for a PUSCH transmission in a slot. For example, the UE applies an actual UL muting pattern on a common DM-RS position to the PUSCH transmission in the slot when parameter DM-RS-AdditionalPosition ‘pos2’ is configured or indicated in the slot, otherwise, e.g., parameter DM-RS-AdditionalPosition ‘pos0’ is configured or indicated in the slot, the UE does not apply the UL muting pattern to the PUSCH transmission in the slot.

In one example, a condition or a restriction associated with UL muting on a common DM-RS position for PUSCH may correspond to UCI/control payload type for the PUSCH transmission in a slot. The UE applies an actual UL muting pattern on a common DM-RS position to the PUSCH transmission in the slot when the UCI/control payload type is CSI or CSI part 1 or CSI part 2 for the PUSCH transmission in the slot, otherwise, e.g., when the UCI/payload type is A/N, the UE does not apply the UL muting pattern to the PUSCH transmission in the slot.

In one embodiment, the UE is provided with a first and a second UL transmission parameter, respectively, for a comb-N muted symbol of a PUSCH on a common DM-RS position when the symbol is used to transmit the comb-N muted symbol and for when the symbol is used to transmit a common DM-RS. For example, a separately provided UL transmission parameter for the symbol may correspond to one or more of the following: an antenna port, a CDM group, a Tx EPRE value, a configured transmission power, or a maximum power reduction value, or a closed loop power control process.

In one example, a comb-N muted symbol location of a PUSCH on a common DM-RS symbol position may use a separately configured or indicated or assigned antenna port number, or a layer mapping, or an antenna precoding when the symbol location is configured or indicated or assigned for common DM-RS transmission or when the symbol location is configured or indicated or assigned for transmission of the comb-N muted symbol. For example, a separate antenna port numbering or assignment, or a separate layer mapping, or a separate precoding may be tabulated and provided to the UE by system operating specifications. For example, a separate antenna port numbering or assignment, or a separate layer mapping, or a separate precoding may be configured or indicated to the UE from a corresponding transmission parameter for the common DM-RS symbol position in the PUSCH when the symbol is used for DM-RS transmission.

In one example, when the UE receives a DCI format such as DCI Format 0_0, or 0_1, or 0_3 with a precoding information and number of layers field or with an antenna ports field for a PUSCH transmission with UL muting on a common UL DM-RS position, when transmitting the comb-N muted symbol on a common DM-RS symbol position, the UE may set a transmission parameter according to the precoding information and number of layers field or the antenna ports field in the UL grant DCI format based on the parameter ulMutingConfig.

In one example, the UE determines a first and a second UL transmit power or a first and a second power reduction value for UL transmissions of a PUSCH with UL muting on a data symbol position or on a common DM-RS symbol position. The first UL transmit power value, or first power reduction value may be associated with UL transmissions of a PUSCH when UL muting is not applied. The second UL transmit power value, or second power reduction value may be associated with UL transmissions of a PUSCH when UL muting is applied.

In one example, a PUSCH configuration in a higher layer parameter ServingCellConfig or PUSCH-Config may be provided to the UE by higher layers and include an UL transmit power adjustment value associated with UL muting. For example, a PUSCH time-domain resource allocation (TDRA) table may be configured for the UE by higher layers and include an UL transmit power adjustment value when UL muting is applied to a PUSCH transmission. For example, the PUSCH time-domain resource allocation table may be configured for the UE by higher layers and include a parameter associated with an UL power adjustment value corresponding to UL muting on PUSCH, e.g., for a row of the PUSCH TDRA table or as a parameter provided in the configuration for the PUSCH TDRA table. For example, the UE may be indicated an entry of a PUSCH time-domain resource allocation table associated with the PUSCH allocation applying the UL muting and an indication to the UE based on a TDRA field in a DCI format. For example, a PUSCH transmission with UL muting based on a TDRA table for a configured grant may provide an UL transmit power adjustment value corresponding to a PUSCH with UL muting to the UE.

In one example, information may be provided to the UE by higher layers to associate a DL or UL reference signal or a DL or an UL or joint TCI state(s) or RS resource index(es) such as corresponding to an SSB or to a CSI-RS resource index with a condition or restriction with respect to an UL transmit power or power reduction value for a PUSCH transmission with UL muting. For example, a first TCI state may correspond to a PUSCH transmission with UL muting associated with a first value for an UL transmit power or power reduction value and a second TCI state may correspond to a PUSCH transmission with UL muting associated with a second value for an UL transmit power or power reduction value.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to transmit a physical uplink shared channel (PUSCH), the method comprising:
receiving first information for a first set of symbols in a slot, wherein the slot is associated with resource element (RE) muting on a symbol from the first set of symbols;
receiving second information for an uplink (UL) grant downlink control information (DCI) associated with transmission of the PUSCH in a second set of symbols in the slot;
receiving third information for a condition;
determining, based on the condition, that a symbol of the second set of symbols is included in the first set of symbols in the slot;
determining a number of symbols associated with RE muting for transmission of the PUSCH on the second set of symbols; and
transmitting the number of symbols from the second set of symbols based on:
the first information when the condition is valid, and
the second information when the condition is not valid.

2. The method of claim 1, wherein the first information includes a maximum allowed number (Jₘₐₓ) of muted symbols.

3. The method of claim 1, further comprising, determining, based on the condition, a number (J) of muted symbols for transmission of the PUSCH, wherein J is less than or equal to Jₘₐₓ.

4. The method of claim 1, further comprising, determining, based on the condition, a number (J) of muted symbols for transmission of the PUSCH, wherein a muted symbol from the number of muted symbols occurs between a first symbol (Jₛₜₐᵣₜ) and a last symbol (J_{end}).

5. The method of claim 1, wherein the condition is at least one of:
a symbol type including a symbol (i) with a demodulation reference signal (DM-RS), (ii) without DM-RS, (iii) with a phase tracking reference signal (PTRS), or (iv) without PTRS;
a symbol or slot type including UL or flexible (F);
a symbol or slot type including subband full-duplex (SBFD) or non-SBFD;
a downlink (DL) or UL reference signal (RS); and
a value or set of values corresponding to an UL or joint transmission configuration indicator (TCI) state or RS resource index.

6. The method of claim 1, wherein the first information corresponds to a higher layer parameter ulMutingConfig, including parameters N and comb, defining muting patterns for symbols within the slot.

7. The method of claim 1 further comprising, determining, based on the condition, a number (J) of muted symbols for transmission of the PUSCH when frequency hopping is not enabled.

8. A user equipment (UE), the UE comprising:
a transceiver configured to:
receive first information for a first set of symbols in a slot, wherein the slot is associated with resource element (RE) muting on a symbol from the first set of symbols;
receive second information for an uplink (UL) grant downlink control information (DCI) associated with transmission of a physical uplink shared channel (PUSCH) in a second set of symbols in the slot; and
receive third information for a condition; and
a processor operably coupled to the transceiver, the processor configured to:
determine, based on the condition, that a symbol of the second set of symbols is included in the first set of symbols in the slot; and
determine a number of symbols associated with RE muting for transmission of the PUSCH on the second set of symbols,
wherein the transceiver is further configured to transmit the number of symbols from the second set of symbols based on:
the first information when the condition is valid, and
the second information when the condition is not valid.

9. The UE of claim 8, wherein the first information includes a maximum allowed number (Jₘₐₓ) of muted symbols.

10. The UE of claim 8, wherein the processor is further configured to determine, based on the condition, a number (J) of muted symbols for transmission of the PUSCH, wherein J is less than or equal to Jₘₐₓ.

11. The UE of claim 8, wherein the processor is further configured to determine, based on the condition, a number (J) of muted symbols for transmission of the PUSCH, wherein a muted symbol from the number of muted symbols occurs between a first symbol (Jₛₜₐᵣₜ) and a last symbol (J_{end}).

12. The UE of claim 8, wherein the condition is at least one of:
a symbol type including a symbol (i) with a demodulation reference signal (DM-RS), (ii) without DM-RS, (iii) with a phase tracking reference signal (PTRS), or (iv) without PTRS;
a symbol or slot type including UL or flexible (F);
a symbol or slot type including subband full-duplex (SBFD) or non-SBFD;
a downlink (DL) or UL reference signal (RS); and
a value or set of values corresponding to an UL or joint transmission configuration indicator (TCI) state or RS resource index.

13. The UE of claim 8, wherein the first information corresponds to a higher layer parameter ulMutingConfig, including parameters N and comb, defining muting patterns for symbols within the slot.

14. The UE of claim 8, wherein the processor is further configured to determine, based on the condition, a number (J) of muted symbols for transmission of the PUSCH when frequency hopping is not enabled.

15. A base station (BS), the BS comprising:
a transceiver configured to:
transmit first information for a first set of symbols in a slot, wherein the slot is associated with resource element (RE) muting on a symbol from the first set of symbols;
transmit second information for an uplink (UL) grant downlink control information (DCI) associated with reception of a physical uplink shared channel (PUSCH) in a second set of symbols in the slot; and
transmit third information for a condition; and
a processor operably coupled to the transceiver, the processor configured to:
determine, based on the condition, that a symbol of the second set of symbols is included in the first set of symbols in the slot; and
determine a number of symbols associated with RE muting for reception of the PUSCH on the second set of symbols,
wherein the transceiver is further configured to receive the number of symbols from the second set of symbols based on:
the first information when the condition is valid, and
the second information when the condition is not valid.

16. The BS of claim 15, wherein the first information includes a maximum allowed number (Jₘₐₓ) of muted symbols.

17. The BS of claim 15, wherein the processor is further configured to determine, based on the condition, a number (J) of muted symbols for reception of the PUSCH, wherein J is less than or equal to Jₘₐₓ.

18. The BS of claim 15, wherein the processor is further configured to determine, based on the condition, a number (J) of muted symbols for reception of the PUSCH, wherein a muted symbol from the number of muted symbols occurs between a first symbol (Jₛₜₐᵣₜ) and a last symbol (J_{end}).

19. The BS of claim 15, wherein the condition is at least one of:
a symbol type including a symbol (i) with a demodulation reference signal (DM-RS), (ii) without DM-RS, (iii) with a phase tracking reference signal (PTRS), or (iv) without PTRS;
a symbol or slot type including UL or flexible (F);
a symbol or slot type including subband full-duplex (SBFD) or non-SBFD;
a downlink (DL) or UL reference signal (RS); and
a value or set of values corresponding to an UL or joint transmission configuration indicator (TCI) state or RS resource index.

20. The BS of claim 15, wherein the first information corresponds to a higher layer parameter ulMutingConfig, including parameters N and comb, defining muting patterns for symbols within the slot.
